(19) United States
(12) Patent Application Publication
(10) Pub. No.: US 2007/0080801 A1
(43) Pub. Date: Apr. 12, 2007

(54) Universal communications, monitoring, tracking, and control system for a healthcare facility

(76) Inventors: Matthew W. Weismiller, Batesville, IN (US); Timothy D. Wildman, Metamora, IN (US); Carl W. Riley, Milan, IN (US); Craig A. McNeely, Columbus, IN (US); Thomas M. Fleck, Batesville, IN (US); Dennis J. Gallant, Harrison, OH (US); Keith Adam Huster, Sunman, IN (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 10/575,801

(22) PCT Filed: Oct. 18, 2004
(86) PCT No.: PCT/US04/34473

§ 371 Date: Nov. 30, 2006

Related U.S. Application Data
(60) Provisional application No. 60/511,737, filed on Oct. 16, 2003.

(51) Int. Cl. G08B 1/08; G08B 5/22

(52) U.S. Cl. 340/539.13; 340/825.36

(57) ABSTRACT

A communication and asset locating and tracking system is provided by a wireless high resolution locating and tracting system having a plurality of receivers that are located in different locations in a facility, such as floors, rooms, corridors, common areas and portions thereof within the facility, the locating system is linked to a wireless communication system having a plurality of access points and voice-activated handfree communicators. By issuing a voice command to the communicator, the location of an asset is determined by the asset location system.

### CROSS-REFERENCE TO RELATED PATENT APPLICATIONS

This application claims the benefit of U.S. Provisional Patent Application Ser. No. 60/511,737, filed Oct. 16, 2003, and is a continuation-in-part of U.S. Utility patent application Ser. No. 10/673,980, filed Sep. 29, 2003, which are hereby expressly incorporated herein by reference in their entirety.

### TECHNICAL FIELD OF THE INVENTION

The present invention relates generally to monitoring systems for improving communications and personnel and asset management in a healthcare facility.

### BACKGROUND AND SUMMARY OF THE INVENTION

Caregivers such as physicians, nurses and other staff in a hospital ward, hospital wing, or other healthcare facility generally work under high pressure, high stress and long hours. These caregivers should be highly responsive to patient needs, in non-emergency as well as emergency situations. Due to ever-increasing costs of healthcare and other economic practicalities, efficient deployment of the caregivers in a healthcare facility is desired, particularly at night when the number of caregivers is typically maintained at a minimum. Nevertheless, optimizing efficiency is of secondary importance relative to the primary objective of providing a high level of healthcare. Accordingly, it is desirable to increase the efficiency of caregivers and improve the healthcare provided to patients.

The present invention provides an integrated, universal communications, tracking, monitoring and control system for a healthcare facility. The system permits direct wireless communication among personnel, wireless access to continuously updated, stored information relating to patients, personnel and other assets, covert or automatic collection of information relating to the movement and status of such patients, personnel and other assets, and control (either manually, such as through voice commands, or automatically) of equipment and environmental features of the facility based on activities and/or the movement or status of patients, personnel or other assets.

In one embodiment of the present invention, “high resolution” location information for patients, personnel, and other assets and/or use or status information for patents, personnel, and other assets is provided along with the capability to perform vanous tasks, communicate, retrieve information, or initiate tasks via a “hands-free” or a “near hands-free” communicator.

A hands-free communicator is herein defined as a device which permits a user to perform various tasks, communicate, retrieve information, or initiate tasks without the usage of one's hands. A near hands-free communicator is herein defined as a device which permits a user to perform various tasks, communicate, retrieve information, or initiate tasks by requiring only minimal usage of one's hands, such as to depress a button to initiate a call. Hands-free communicators and near hands-free communicators may be either portable devices which are carried by, worn by, or associated with patients, personnel, and/or other assets, or fixed devices either associated with a patient, a personnel member, an asset, or location.

It should be understood that a hands-free communicator is not required to be hands-free for all operations nor is a near hands-free communicator required to be limited to minimal usage of one's hands. On the contrary, a hands-free communicator can also facilitate “hands on” interaction to perform certain tasks and still be considered a hands-free communicator if it is capable of allowing a user to perform tasks, communicate, retrieve information or initiate tasks by a hands-free operation such as initiating a call with a voice command. Similarly, a near hands-free communicator can also facilitate “hands-on” interaction to perform certain tasks and still be considered a near hands-free communicator if it is capable of allowing a user to perform tasks, to communicate, retrieve information, or initiate tasks by a near hands-free operation such as initiating a call with a voice command.

Additional features of the present invention will be evident from the following description of the drawings and exemplary embodiments.

### BRIEF DESCRIPTION OF THE DRAWINGS

FIG. 1 is a block diagram of one embodiment of a system according to the present invention.

FIG. 2 is a block diagram of an expanded system according to the present invention.

FIG. 3 is a side elevational view of a room including a plurality of components of the system shown in FIG. 2.

FIG. 4 is a side elevational view of a pass through wall component of the system shown in FIGS. 1 and 2.

FIGS. 5A-C are system architecture diagrams for portable communicators interfacing with the system of FIG. 1.

FIG. 6A is a block diagram of a hands-free portable communicator.

FIG. 6B is a block diagram of a near hands-free portable communicator.

FIG. 7A is a flowchart of an exemplary monitor routine for the hands-free portable communicator of FIG. 6A.

FIG. 7B is a flowchart of an exemplary standby routine for the near hands-free portable communicator of FIG. 6B.

FIG. 8A is a block diagram of one embodiment of a hands-free fixed communicator.

FIG. 8B is a block diagram of one embodiment of a near hands-free fixed communicator.

FIG. 9 is a flowchart of an exemplary call routine.

FIG. 10 is a flowchart of an exemplary receive call routine.

FIG. 11 is a flowchart of an exemplary send message routine.

FIG. 12 is a flowchart of an exemplary receive unheard message routine.

FIG. 13 is a flowchart of an environmental setting routine.

FIG. 14 is a flowchart of an exemplary navigation assistance routine.

FIG. 15 is a flowchart of an exemplary secure access routine.

FIG. 16 is a flowchart of an exemplary unauthorized movement routine.

FIG. 17 is a flowchart of an exemplary request location routine.

### DETAILED DESCRIPTION OF EXEMPLARY EMBODIMENTS

While the invention is susceptible to various modifications and alternative forms, exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention as defined by the appended claims.

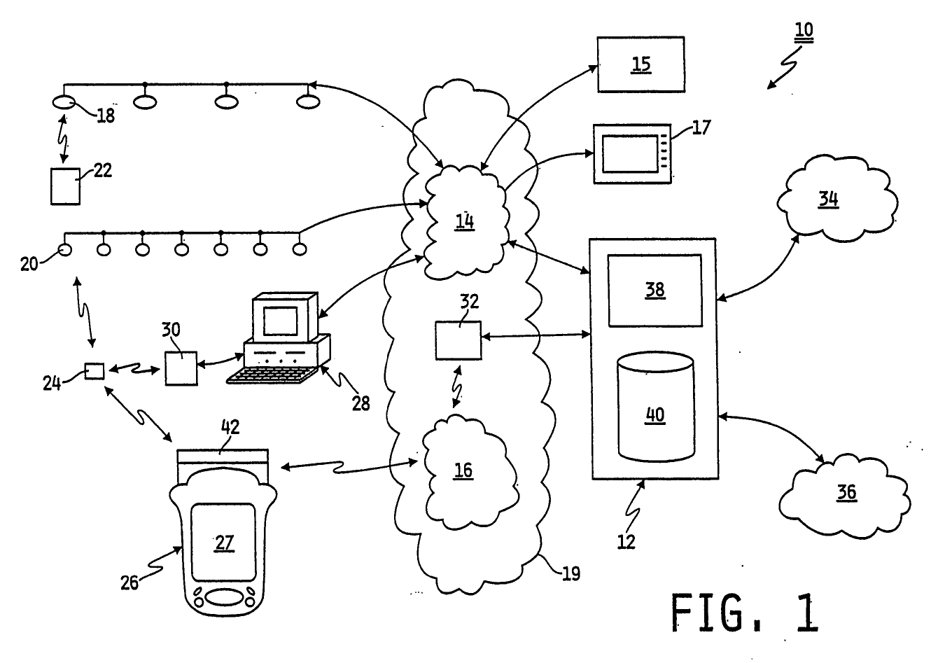

FIG. 1 shows components of a system according to one embodiment of the present invention. System 10 of FIG. 1 generally includes a server 12, a first network 14, a second network 16, a plurality of first transceivers 18 connected to first network 14, a plurality of second transceivers 20 connected to first network 14, a plurality of active tags 22 (only one shown), a plurality of passive tags 24 (only one shown), a plurality of client devices 26 (only one shown), a plurality of work stations 28 (only one shown), each connected to an interface 30 and to first network 14, and a plurality of routers 32 connected to second network 16 and server 12. As is also shown in FIG. 1, server 12 may further be coupled to a hospital information system network, network 34, and another communications network 36 external to the facility in which system 10 is installed, for example, the internet. Also coupled to network 14 are a plurality of other systems collectively designated 15 (as further described below) and a plurality of display devices 17 (only one shown) such as monitors, electronic white boards, etc.

Server 12 may be any of a variety of conventional computing devices such as a mainframe computer, a workstation computer, a personal computer, etc. As will be apparent to one skilled in the art, server 12 may be selected based on speed, memory capacity, and other performance characteristics necessary for providing the communications and data handling functions described herein. Server 12 is depicted as a single device having logic software 38 and a database 40, both of which are stored in a conventional storage media (not shown) coupled to server 12. It should be understood, however, that server 12 may be implemented as a plurality of separate servers connected together over a network. Also, database 40 may include multiple databases (each containing a different type or amount of information). Database 40 may further be a distributed database, having portions stored in a plurality of different locations. For simplicity, server 12 is referred to herein as a single, central server having a single database 40.

Network 14 and network 16 may be implemented as a single network (indicated in FIG. 1 as network 19) that is wired, wireless, or a combination of wired and wireless. In one embodiment of the invention, network 14 is a wired network such as a conventional wired Ethernet. Accordingly, transceivers 18, transceivers 20, workstations 28, other systems 15 and displays 17 are coupled to network 14 using conventional wire technology. In such an embodiment, network 16 is a wireless communication network such as a wireless Ethernet conforming to the 802.11(b) communications standard. As such, network 16 includes a plurality of conventional access points 21 positioned at various locations throughout the facility such as in patient rooms, hallways, or other locations. As is well known in the art, the spacing between such access points 21 should be such that wireless devices in communication with network 16 will always be within range of an access point 21, thereby providing complete coverage of the facility or a section of the facility. Network 16 is in communication with server 12 via routers 32 which process communications between network 16 and server 12 according to principles that are well known in the art.

Transceivers 18 are of the type suitable for an equipment and/or personnel locating and tracking system. In one embodiment of the invention, transceivers 18 are of the type suitable for use with active tags 22 that periodically transmit an identification signal to receivers (not shown) in transceivers 18 using active infrared (IR), active radio frequency (RF), or other suitable communications technology. Transmitters (not shown) in transceivers 18 similarly transmit signals to active tags 22 using active communications technology. As is well known in the art, transceivers 18 are mounted at various locations throughout the facility such as in patient rooms, hallways, and other locations. The location of each transceiver 18 is known by server 12. Thus, when a particular transceiver 18 receives an identification signal from an active tag 22 and forwards a message to server 12 via network 14 including the identification signal, server 12 can determine that active tag 22 is within range of the particular transceiver 18. Thus, server 12 can access database 40 to determine which person or piece of equipment has been associated with the active tag 22 that transmitted the identification signal. The location of the associated person or piece of equipment may then be updated as being in proximity of the particular transceiver 18 (e.g., within a particular patient room).

Transceivers 18 and transceivers 20 are shown as two separate sets of transceivers to indicate two different types of locating technology. In one embodiment of the invention, transceivers 20 are RFID transceivers suitable for communications with RFID tags 24 using either passive or active RFID technology. A full description of suitable transceivers and RFID tags is included in co-pending

U.S. patent application Ser. No. 10/154,644, entitled “A WASTE SEGREGATON COMPLIANCE SYSTEM,” filed May 24, 2002, the disclosure of which is hereby expressly incorporated herein by reference. As further described herein, transceivers 20 may be mounted at various locations throughout the facility such as near or on hygiene equipment, waste disposal equipment, patient beds, door jams, care zones adjacent patient beds, family zones within patient rooms, openings in walls though which supplies are passed (as further described herein), facility shipping and receiving areas, hallways, nursing stations, and any other desired location within the facility. As is also further described herein, RFID tags 24 may be mounted to items worn or carried by people, including the hands-free communicators and the near hands-free communicators described herein, equipment, and supplies of any type (collectively referred to herein as assets). Each RFW tag 24 is associated in database 40 with the asset to which the tag is assigned based on the unique identification signal generated by the tag. Transceivers 20 receive these identification signals from RFID tags 24, and transmit messages to server 12 via network 14 that identify RFID tags 24 within range of transceivers 20. Since the location of each transceiver 20 and the association between RFID tags 24 and the assets to which they are assigned are known (and stored in database 40), server 12 can access database 40 to determine (and/or update) the location of each asset having an RFID tag 24 as further described herein.

Additional details concerning the structure and function of suitable systems for locating and tracking assets and to support various other features of the present invention are disclosed in U.S. Pat. Nos. 5,561,412, 6,344,794, co-pending U.S. patent application Ser. No. 09/751,241, entitled “PERSONNEL AND ASSET TRACKING METHOD AND APPARATUS,” filed Dec. 29, 2000, co-pending U.S. patent application Ser. No. 09/699,796, entitled “HYGIENE MONITORING SYSTEM,” filed Oct. 30, 2000, co-pending U.S. Provisional Patent Application Ser. No. 60/462,216, entitled “ARTICLE LOCATING AND TRACKING APPARATUS AND METHOD,” filed Apr. 11, 2003, and co-pending U.S. patent application Ser. No. 10/141,457, published as U.S. Published Application No. US2002/0183979A1, entitled “ARTICLE LOCATING AND TRACKING SYSTEM,” filed May 8, 2002, the disclosures of which are hereby expressly incorporated herein by reference. Additional location and tracking systems are disclosed in U.S. Pat. Nos. 4,275,385; 4,601,064; Re 35,035; 5,633,742; 5,745,272; 5,818,617; 5,119,104; 5,387,993; 5,548,637; 5,572,195; 5,291,399; 5,455,851; 5,465,082; 5,515,426; 5,594,786; 5,689,229; 5,822,418; 5,822,544; 5,699,038 and 5,838,223, the disclosures of which are hereby expressly incorporated herein by reference.

Client device 26 may include any of a variety of conventional portable computing and communication devices including laptops, tablet PCs, pocket PCs, mobile PCs, and PDAs. Client device 26 includes wireless functionality for communications over network 16. Accordingly, client device 26 includes a transceiver module, a microphone, and a speaker (none shown). One suitable client device 26 is a Compaq iPAQ H3600, H3700 and H3800 Series Pocket PC with a Compaq iPAQ Pocket PC Wireless Pack for 802.11x wireless (e.g., Wi-Fi) or GSM/GPRS Networks. The hands-free communicator and near hands-free communicators described herein are exemplary client devices 26. Client device 26 further includes a display 27, and an RFID interface 42 for reading information from RFID tags 24 and writing information to RFID tags 24 as is further described below. RFID interface 42 may be any of a variety of conventional RFID readlwrite devices such as those available from Northern Apex of Indiana, and is coupled to client device 26 according to principles that are well known in the art. While both client device 26 and workstation 28 are described herein as including RFID interfaces 30, 42, is should be understood that bar code technology (or other suitable technology) could readily be used instead of or in addition to RFID technology.

Client device 26 may be configured as a thin client such that client device 26 obtains information as needed from server 12 via network 16, and only a minimal amount of data is actually stored in the memory (not shown) of client device 26. It should be understood, however, that client devices 26 may alternatively store information obtained by system 10 in a distributed database configuration as mentioned above. In such an embodiment, client devices 26 may share information over network 16 rather than access information stored in a central location such as database 40. It should also be understood that client devices 26 may communicate directly with one another without accessing an access point of network 16 so long as the client devices 26 are within range of one another. This communication may include text, audio and/or video content. Additionally, client device 26 may include a cellular telephone or pager to permit direct communications with systems that are external to the facility (such as cell phone networks). It is also within the scope of the invention to interface either of networks 14, 16 with a PBX to permit communications between client devices 26 using the 802.11(b) or another wireless communication standard and conventional telephones using the Plain Old Telephone System (POTS).

Finally, client devices 26 may also include one of tags 22, 24 to permit locating and tracking of client devices 26 (in addition to any tags 22, 24 worn by the user of a client device 26). This feature could be a theft deterrent or used as a reminder for charging the battery (not shown) of client device 26. For example, if a client device tag 22, 24 is detected by an appropriate transceiver 18, 20 at an exit to the facility, software 38 of server 12 could be configured to activate an alarm, transmit a message to security personnel, or otherwise automatically respond to the potential theft. As another example, a battery charging station for client devices 26 may include an appropriate transceiver 18, 20 for detecting the presence of client devices 26. Software 38 may be configured to transmit a message to appropriate personnel to retrieve a client device 26 from its known location if the client device 26 is not detected at the battery charging station at a certain time (e.g., within one hour after the shift of the person associated with the client device 26). It should be understood that some information relating to the location of client device 26 may be obtained simply by determining the access point 21 used by client device 26 to connect to network 16. Such information is transmitted to server 12 which, based on the known locations of the access points 21, can determine a general area (corresponding to the reception area of the access point) in which client device 26 is operating.

Workstations 28 may also include any suitable type of computing device having sufficient performance characteristics to function as described herein. In one embodiment of the invention, workstations 28 are PCs at essentially fixed locations throughout the facility. For example, workstations 28 may be located in an admissions area, at nurse stations throughout the facility, in administrative areas, etc. Some or all of workstations 28 may be coupled to an RFID interface 30 similar to RFID interface 42 described above. Workstations 28 may also be configured to function as thin client devices, and primarily access information from server 12 via network 14. Alternatively, workstations 28 may be configured to function in a server-like fashion, collecting information directly via an input device such as a keyboard, and from a plurality of transceivers 18, 20 in proximity to workstation 28. In such an embodiment, each workstation 28 may communicate information with server 12 and other workstations 28, while maintaining a database of information corresponding to the components of system 10 in proximity to (or otherwise associated with) workstation 28.

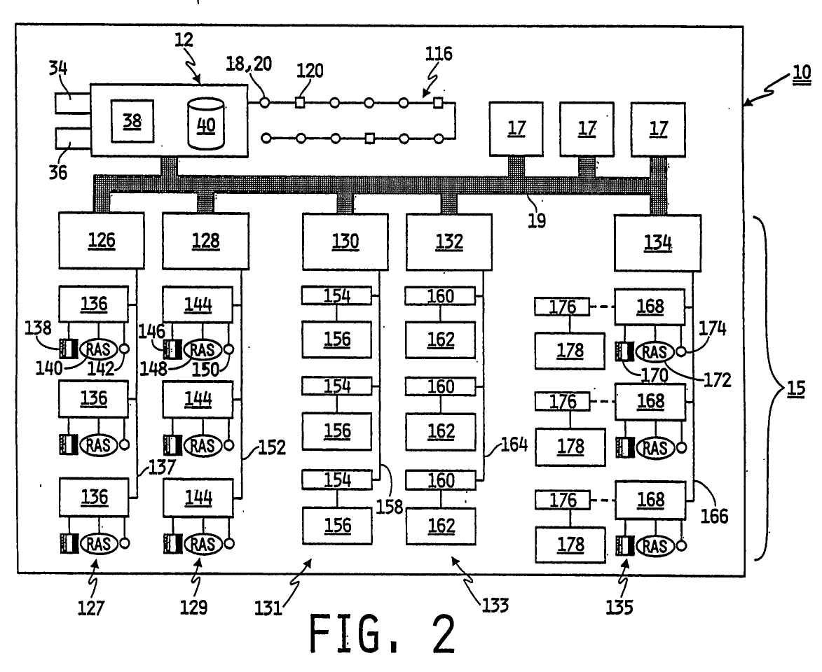

As should be apparent from the foregoing, other systems 15 connected to network 14 may provide additional information to server 12 or enhance the functionality of system 10. FIG. 2 depicts such an architecture of system 10. System 10 includes an enterprise server 12 that may correspond to the central server 12 described above. Enterprise server 12 is coupled to networks 34, 36 as described above. Server 12 is further coupled to a network 116 that includes transceivers 18 and/or transceivers 20 and manual data input devices 120 such as keypads, keyboards, touch screens, voice activated input devices, barcode readers, biometric recognition devices, etc. Server 12 of system 10 is coupled to a plurality of other servers (described below) and display devices 17 by network 19 described above. Display devices 17 may be monitors, electronic whiteboards, computer displays, displays of client devices 26, or any other type of device for displaying information. Network 19 may correspond to networks 14, 16 of system 10 or any other suitable local area or wide area network.

The plurality of additional servers connected to network 19 include a first nurse call server 126 of a first communications system 127, a second nurse call server 128 of a second communications system 129, a first equipment monitoring server 130 of a first monitoring system 131, a second equipment monitoring server 132 of a second equipment monitoring system 133, and a universal server 134 of a combined communications and equipment monitoring system 135. First nurse call server 126 may be a server such as that used in the COMposer® communication system available from Hill-Rom. Some details of the COMposer® communication system are disclosed in U.S. Pat. Nos. 5,561,412, 5,699,038, and 5,838,223, which are hereby expressly incorporated herein by reference. As explained in the COMposer® patents, first nurse call server 126 is coupled via a DXP switching network 137 to a plurality of room boards 136 located in patient rooms. Each room board 136 is coupled to an indicator light 138, a room audio station (RAS 140), and a plurality of input and output devices such as other lights, switches, and sensors (collectively referred to by the designation 142).

Essentially, first nurse call server 126 controls communications among caregivers and patients and provides various status indications of certain conditions. For example, first nurse call server 126 may receive a nurse call request generated by a patient at an input device 142 such as a nurse call button. The signal may be transmitted to first nurse call server 126 via room board 136. First nurse call server 126 may then transmit a signal to a pager (not shown) carried by the appropriate caregiver or to a hands-free communicator or near hands-free communicator carried by the appropriate caregiver. First nurse call server 126 may further cause room board 136 to change the appearance of indicator light 138 (positioned, for example, outside the patient's room) to indicate that the patient has placed a call to receive assistance from a caregiver. The caregiver may respond to the call by using an intercom system (part of first nurse call server 126) or by using a hands-free communicator or near hands-free communicator to contact the patient through RAS 140 (including a speaker, microphone and a display) located in the patient's room.

Another of the input devices 142 coupled to room board 136 is a code blue switch (not shown), activation of which results in automatic transmission by first nurse call server 126 of notification signals to appropriate caregivers, and a change in the appearance of indicator light 138 to indicate a code blue situation. Information describing any and all of the communication traffic and other functions performed by first communication system 127 controlled by first nurse call server 126 may be provided to server 12 via network 19. This information may permit system 10 to notify appropriate personnel of certain conditions or otherwise automatically respond to certain conditions as further described herein.

Second communications system 129 is similar to first communications system 127. Second communications system 129 may be the COMlinx™ communications system available from Hill-Rom and described in the COMlinx™ Enterprise Solutions User's Guide and System Configuration Guide, and the Nurse Communication Module Installation and Service Guide, all of which are hereby expressly incorporated herein by reference. System 129 includes components that are similar to those of system 127, including room controllers 144 located in patient rooms. Each room controller 144 is connected to an indicator light 146, a RAS 148, and a plurality of input and output devices collectively referred to by designation 150. Room controllers 144 are connected to second nurse call server 128 by a data and voice network 152. Second nurse call server 128 may provide similar information to server 12 as that provided by first nurse call server 126.

First equipment monitoring server 130 of first equipment monitoring system 131 is connected to a plurality of data acquisition and display devices (DADDs 154) which in turn are coupled to fetal monitoring equipment 156. Each DADD 154 is coupled to a data network 158. First equipment monitoring system 131 may be an obstetrical patient data management system such as the WatchChild system available from Hill-Rom and described in the WatchChild User's Guide and System Configuration Guide, which are hereby expressly incorporated herein by reference. First equipment monitoring server 130 may therefore provide information to server 12 via network 19 describing the output of the various fetal monitoring equipment 156.

Second equipment monitoring system 133 is simply a more generalized version of first equipment monitoring system 131. More particularly, second equipment monitoring server 132 is coupled via data network 164 to a plurality of DADDs 160 configured to receive, display, and transfer information from any of a plurality of different monitoring equipment 162 such as cardiac monitoring equipment, etc. Accordingly, second equipment monitoring server 132 may provide information to server 12 via network 19 describing the output of the various other monitoring equipment 162.

Universal server 134 of combined communications and equipment monitoring system 135 is coupled via data and voice network 166 to a plurality of room controllers 168 located in a plurality of patient rooms. Room controllers 168 are coupled to indicator lights 170, RASs 172, and a plurality of input and output devices collectively referred to by designation 174. Room controllers 168 are further coupled to one or more DADDs 176 in the room, which in turn are coupled to a plurality of other devices 178 such as monitors, beds, and other equipment in the room. Accordingly, universal server 134 receives information including communications information and equipment output and status information in the manner described above with reference to the other systems coupled to network 19. As such, universal server 134 may provide any of the above-described information to server 12 via network 19 in the manner described above. It should be noted that the connection between RASs 172 and room controllers 168 and between DADDs 176 and room controllers 168 are indicated by dotted lines to denote wireless connections. Any of the connections between the various components, however, could readily be implemented using wired or wireless technology.

Additionally, a plurality of patient point of care devices may be coupled to network 19 such as those disclosed in co-pending U.S. patent application Ser. No. 10/211,451, entitled “Point of Care Computer System,” filed Aug. 2, 2002, and hereby expressly incorporated herein by reference. As described in the '451 application, such point of care devices may provide information regarding meals, entertainment uses, scheduling, and messaging that may readily by stored on database 40, and accessed by appropriate facility personnel using, for example, client devices 26 including the hands-free communicators and the near hands-free communicators described herein or workstations 28, for responding to patient needs, billing for goods and services, or otherwise monitoring and/or controlling a patient's use of the features provided by the point of care device.

Moreover, any combination of the above-described systems (and any number of systems of the same type) may be coupled to server 12 via network 19. It is further within the scope of the invention to couple multiple systems 10 together over a network such as network 36. In such an embodiment, a data warehouse may be provided wherein multiple facilities share information from their respective databases 40 with a central database at the data warehouse. The data warehouse may include an automatic archival function wherein certain data is saved to a permanent storage media, and a reporting feature wherein reports relating to the operations of the facilities are generated and automatically transmitted to the facilities.

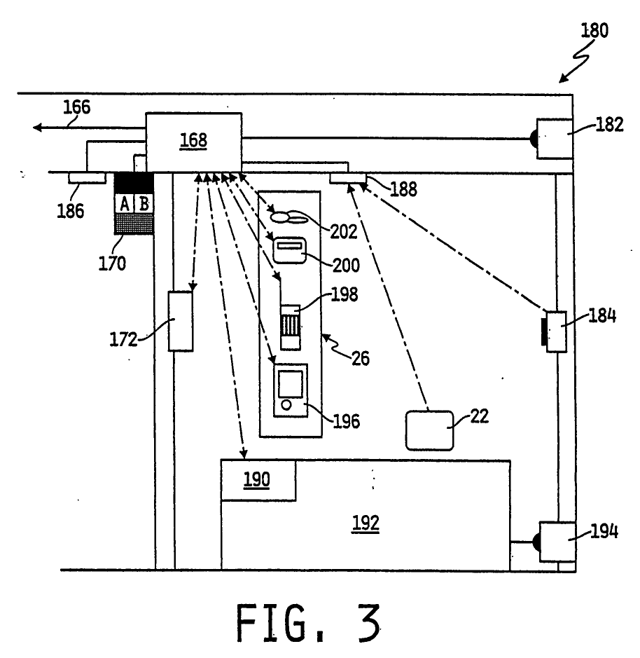

FIG. 3 depicts a room 180 incorporating some of the above-described components of system 10. More specifically, room 180 depicts an example of a portion of combined communications and equipment monitoring system 135. Room 180 includes a room controller 168 powered by an AC power outlet 182 and/or a DC power back-up system (not shown). As also shown in FIG. 2, room controller 168 is coupled to a data and voice network 166, an indicator light 170, and a RAS 172. The plurality of input and output devices 174 of FIG. 2 are depicted in FIG. 3 as a wall switch 184, a first sensor 186, a second sensor 188, and a client device 26. DADD 176 and device 178 of FIG. 2 are depicted in FIG. 3 as a bed station 190 mounted to a bed 192 powered by an AC power outlet 194.

In the illustrated embodiment, sensors 186, 188 are of the same technology as either of transceivers 18 or 20. Sensors 186, 188 are associated with room controller 168 because they are used to perform certain nurse call locating activities. For example, when a caregiver enters room 180 wearing active tag 22, sensor 188 receives an identification signal from active tag 22 and transmits a signal to room controller 168, which is forwarded to universal server 134. Room controller 168 responds to the identification signal from sensor 188 by, for example, changing the activated status of indicator light 170 to indicate that a caregiver is in room 180. Sensor 186 similarly senses the caregiver leaving room 180 and cause room controller 168 to change the activated status of indicator light 170 to indicate that a caregiver is no longer in room 180. Of course, the location information about the caregiver may also be forwarded from universal server 134 via network 19 to server 12. Additionally, sensor 188 may be configured to receive a wireless signal from wall switch 184 such as a nurse call signal or a code blue signal.

Client device 26, as depicted in FIG. 3, includes the combined functions of a pocket PC 196 (generically referred to as a handheld computer), a wireless telephone 198, a pager 200, and a headset 202. Of course, as shown in FIG. 1, client device 26 may further include an RFID interface 42 for reading information from and writing information to RFID tags 24 as further described below.

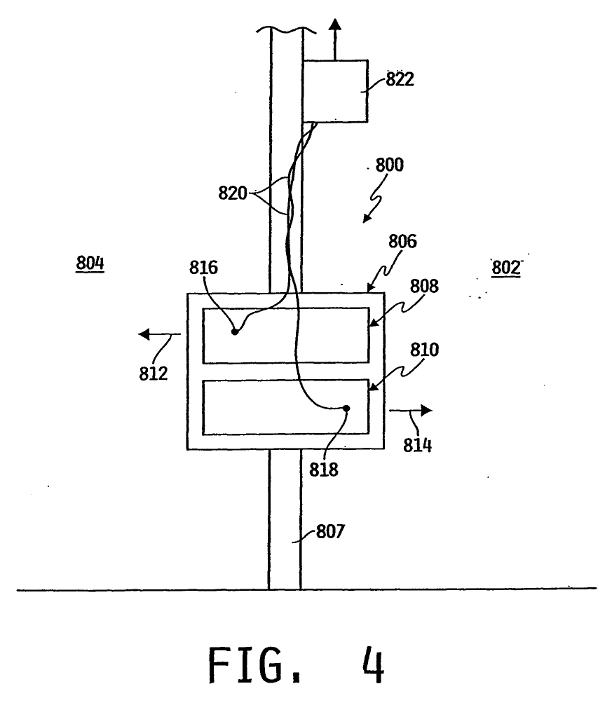

The voice over IP communications features provided by client device 26 are as shown and described in FIGS. 4-19 and the accompanying disclosure of the co-pending parent application Ser. No. 10/673,980.

Among other things, the various networks and systems described above provide automatic data collection that may be used in a plurality of different ways. By receiving continuously updated information about the location of the various people, equipment, and supplies, system 10 maintains an accurate database (such as database 40) of the current locations of such assets. Additionally, by retaining a history of such location data, the status of assets may readily be determined by applying certain logical rules. For example, if a caregiver is detected at a handwashing station, then system 10 may update the caregiver's hygiene compliance status to “clean.” If a caregiver leaves a patient's room without washing his or her hands, then system 10 may update the caregiver's hygiene compliance status to “contaminated.” If the caregiver then enters another patient's room, system 10 may automatically prompt the caregiver to wash his or her hands by sending a message to client device 26 associated with the caregiver, activating a light attached to active tag 22 worn by the caregiver, causing indicator light 170 to flash or otherwise indicate a warning condition, causing an automatic message to be played over RAS 172, or otherwise urging compliance with the facility hygiene policy. Other details regarding hygiene compliance applications for system 10 are described in the co-pending U.S. patent application Ser. No. 09/699,796, entitled “HYGIENE MONITORING SYSTEM,” filed Oct. 30, 2000 and referenced above.

Another application of system 10 is automatic dispatching of messages. For example, when wall switch 184 is activated to indicate a code blue condition, the location of the code blue source may be determined by system 10 as well as the identities of caregivers in proximity of room 180. System 10 may then automatically transmit a code blue message indicating the location of the code blue source to those caregivers nearest to the source. Such messages may be transmitted as text (e.g., an email message) over network 16 to client devices 26 carried by the caregivers. Client device 26 may be configured to activate an audible indicator (e.g., the speaker of client device 26) to notify the caregiver of the receipt of a code blue message. As further described herein, the code blue message, in one example, is an audio message provided to client devices 26, such as hands-free communicators or near hands-free communicators.

Additionally, system 10 may cause transmitters 18 to transmit a signal to an active tag 22 worn by the caregiver to activate a light on tag 22 to indicate that a code blue message has been sent to the caregiver. The caregiver may then respond to the code blue condition by entering room 180. Movement of the caregiver into room 180 may be detected by either of transceivers 18, 20 (FIG. 1) or sensor 188 (FIG. 3). The presence of the caregiver in room 180 may then cause system 10 to send another signal to client device 26 to clear the code blue message. If a caregiver does not respond to the code blue message within a predetermined time period, additional caregivers (e.g., caregivers farther from the code blue source) may be automatically notified by system 10 of the code blue condition. Any other type of activity based automatic notification process may be employed using system 10

Another application of system 10 is associating information with assets and updating the information to indicate the present status of the assets. In one embodiment, system 10 facilitates association of information with patients, caregivers, and other assets in a hospital and, in addition to automatically updating the associated information as further described herein, enables caregivers, administrators, and other personnel to update the information as the status of the tagged person or other asset changes. In this embodiment, a patient may be processed using a conventional admissions procedure wherein information relating to the patient is manually entered at a processing terminal such as workstation 28. This information may then be provided to server 12 via network 14 for storage in database 40. Additionally, RFID interface 30 may be used to create an RFID tag 24 for the patient as further described below. RFID tag 24 may include a conventional plastic wristband with an RFID device attached thereto (or printed thereon using an RFID printer as described in co-pending U.S. patent application Ser. No. 10/154,644 referenced above). As the patient moves throughout the facility as detected by transceivers 20, the location information associated with the patient (as identified by the RFID unique identification number stored in the memory (not shown) of RFID tag 24) may be automatically updated by server 12 in database 40. As is also further described herein, caregivers and/or other personnel may write information to the patient's RFID tag 24 to indicate the occurrence of certain events including administration of medications, completion of therapies, evaluations, etc. This updated status information may be read by transceivers 20 (or RFID interfaces 30 or 42), transmitted over the appropriate network 14, 16 or combination thereof, and stored in database 40 by server 12. One software application for associating information with RPD tags 24 is depicted in FIGS. 20-33 and described below.

The RFID features of the present invention are as shown and described in FIGS. 20-43 and the accompanying disclosure of the parent application, Ser. No. 10/673,980.

FIG. 4 depicts another feature of one embodiment of system 10 for monitoring the status and movement of assets within the facility. FIG. 4 depicts a pass through wall 800 for moving assets between area 802 and area 804. Pass through wall 800 may include a housing 806 mounted within a wall 807 supporting a pair of movable drawers 808, 810. It should be understood that in accordance with the principles of the present invention, one or more drawers may be used, and such drawers may be arranged in any desired fashion relative to one another in addition to the vertically stacked arrangement shown in FIG. 4. Also, the drawers may be housed separately and spaced apart from one another such that one drawer extends through one wall of a room and another draw extends through another wall of the room. Moreover, the drawers may be of any acceptable configuration or shape. In fact, a simple opening in a wall or barrier may be configured as a pass through wall according to the present invention, with no moving parts.

In the example shown in FIG. 4, drawer 808 is designated for moving assets into area 804 as indicated by arrow 812, and drawer 810 is designated for moving assets out of area 804 as indicated by arrow 814. Mounted adjacent drawer 808 is at least one RFID sensor 816 for reading unique identification numbers stored on RFID tags 24 associated with assets moved from area 802 to area 804 in drawer 808. Similarly, at least one RFID sensor 818 is mounted adjacent drawer 810 for reading unique identification numbers from RFID tags 24 associated with assets moved from area 804 to area 802 in drawer 810. In one embodiment of the invention, a pair of RFID sensors 816 are mounted adjacent drawer 808 (e.g., one on either side of drawer 808). Additionally, a pair of RFBD sensors 818 are mounted adjacent drawer 810 in a similar fashion. RFID sensors 816, 818 are connected via conductors 820 (e.g., coax) to an interface module 822. In one embodiment of the invention, RFID sensor 816, 818 are conventional RFID antenna, and interface 822 is a conventional RFID interface that provides power to sensors 816, 818, interprets the signals provided by sensor 816, 818, and provides a serial output to a computing device. In this embodiment, interface 822 may be connected to a personnel computer or workstation 28 coupled to server 12 via network 14. Workstation 28 may be used to configure pass through wall 800 by assigning a location to each of RFID sensors 816, 818 and a direction for the drawers monitored by sensors 816, 818. For example, RFID sensors 816 may be associated with a particular patient's room (area 804) and designated to indicate movement of assets through drawer 808 into area 804. RFID sensors 818 may be also associated with area 804 and designated to indicate movement of assets out of area 804 through drawer 810. As such, when RFID sensors 816 detect an identification number from an RFID tag 24 associated with a particular asset, system 10 can interpret the corresponding signal from interface 822 as indicating the movement of that asset into area 804. Signals detected by RFID sensors 818 may similarly indicate movement of assets out of area 804.

One use of pass through wall 800 includes controlling (in addition to monitoring) the movement of assets into and out of, for example, a patient's room. For example, when assets such as used bed linens are moved out of area 804 into drawer 810, sensors 818 detect the presence of the RFID tag 24 attached to the bed linens, and interface 822 provides a signal to workstation 28 indicating the presence of the bed linens in drawer 810. The software of the present invention is configured to interpret the presence of bed linens in drawer 810 by associating a contaminated status with the bed linens in database 40 of server 12. Facility personnel responsible for collecting contaminated bed linens may be notified in any of the ways described above to collect the bed linens disposed in drawer 810. If the bed linens are taken to a cleaning area to be laundered, transceivers 20 located in the cleaning area may detect the presence of RFID tag 24 associated with the bed linens and transmit the new location information to server 12 in the manner described above. Logic software 38 of server 12 may determine, based upon the presence of the bed linens in a cleaning area, that the status of the bed linens should be changed to “cleaned.” As such, the bed linens may be moved into another patient's room or back into area 804 through drawer 808. If, on the other hand, facility personnel attempt to return the bed linens to area 804 prior to cleaning them, sensors 816 will detect the presence of the bed linens in drawer 808 by reading the identification number of the RFID tag 24 associated with the bed linens. Interface 822 will notify workstation 28 and server 12 in the manner described above. Workstation 28 or server 12 may then activate a lock out feature such as a mechanical or electromechanical lock that prevents movement of drawer 808 into area 804. Additionally, an alarm may be sounded or a visual indication of the lock out condition may be provided to alert personnel of an attempt to move a contaminated asset into area 804.

It should be understood that RFID sensors 816, 818 may, like RFID interfaces 30, 42 described above, also include the ability to write information to RFID tags 24. In such an embodiment, RFID sensor 818 could write information to RFID tag 24 associated with the bed linens when the bed linens are placed in drawer 810 to indicate in the memory of RFID tag 24 that the bed linen status is “contaminated.” As such, even if server 12 is inoperable for some reason, the contaminated status of the bed linens may still be detected by RFID sensors 816, 818 when the bed linens are placed into drawer 808. Accordingly, workstation 28 may initiate a lock out condition as described above without accessing status information stored in database 40 in association with RHID tag 24 attached to the bed linens. Obviously, the movement and status of any of a variety of different types of assets may be monitored and controlled in the manner described above.

The above-described linen example is illustrative of the types of business rules incorporated into logic software 38 of server 12. Any of a variety of types of responses to detected situations may be implemented by system 10. For example, by detecting the movement of a patient from a location such as an operating room (via RFID tag 24 associated with the patient), logic software 38 may automatically cause server 12 to issue messages to appropriate personnel to prepare a recovery room or deliver required equipment to the destination of the patient. If, after a predetermined period of time, server 12 does not receive information from transceivers 18, 20, client devices 26, workstations 28, or otherwise, indicating that the patient is located in an acceptable location, accompanied by appropriate personnel, equipment and supplies, server 12 may again issue messages in the manner described above to personnel responsible for ensuring the appropriate response to movement of the patient out of the operating room. In this manner, system 10 not only monitors heath care situations, but automatically intervenes and corrects inappropriate responses to situations based on predetermined business rules. Moreover, logic software 38 may be configured such that it automatically modifies certain business rules based on data reflecting historical responses to situations using available principles of artificial intelligence.

Another example of activity based responses enabled by system 10 involves the discharge or transfer of a patient. When system 10 detects movement of a patient as described above in conjunction with receipt of a discharge order, for example, from a physician using client device 26, system 10 may automatically respond based on a predetermined protocol. For example, an automatic message may be distributed to a receiving nurse and a receiving charge nurse to indicate that the discharge has initiated. Other personnel copied on the message may include dietary personnel (to avoid misrouting of future meals), pharmacy and IV personnel (to avoid misrouting of equipment and medicine), housekeeping personnel (to permit prompt cleaning of the vacated room), case management personnel, therapy personnel, and other physicians associated with the patient. Family members may further be notified of changes in location or status of patients by automatic posting of information to displays 17 positioned within the facility for viewing by family members, etc. Periodic follow-up messages may automatically be sent if the desired movement of appropriate personnel and/or equipment, or the desired changes in status of the patient or assets are not detected by system 10 in the manner described herein.

It should be understood that interface 822 and workstation 28 may utilize conventional anti-collision technology to enable RFID sensors 816, 818 to simultaneously process signals from a plurality of different RFID tags 24 placed in drawers 808, 810. It should further be understood that pass through wall(s) 800 could be located at a centralized or distributed receiving area for inventory tracking purposes, at a centralized or distributed shipping area to monitor movement out of the facility of materials such as contaminated items, biological samples in containers having RFID tags 24 attached thereto, or other items. Additionally, pass through wall 800 may be used to track and control movement of medications such as initiating an above-described lock out condition if the medication detected by RFID sensors 816 are not associated with, for example, a patient located in area 804 as indicated by data stored in database 40.

Additionally, assets that require preventative maintenance after a certain number of uses may be monitored using pass through wall 800. For example, information reflecting the number of uses of a particular asset may be updated each time the asset is detected as moving into and out of area 804. This updated use information may be stored in database 40, in the memory of RFID tag 24 associated with the asset, or both. When the number of uses exceeds a predetermined threshold indicating the need for preventative maintenance, logic software 38 of server 12 may automatically change the status information associated with the asset in database 40 to “unavailable” and send notification to the appropriate facility personnel responsible for completing the preventative maintenance required. Of course, information describing the use and/or consumption of assets (e.g., IV pumps, medication, etc.) may be provided to server 12 in the manner described above and used for accounting purposes such as billing the patient.

In one embodiment as stated herein, system 10 provides a high resolution of location data by the detection of tags 22 by transceivers 18 and the detection of tags 24 by transceivers 20. Examples of high resolution include the ability to distinguish the location of a patient, personnel, or other asset between floors of a facility, the ability to distinguish the location of a patient, personnel, or other asset between rooms, common areas, corridors, and/or other sub-divisions of a facility, and/or the ability to distinguish the location of a patient, personnel, or other asset between sub-areas within a room, corridor, common area, and/or other sub-divisions of a facility, such as near a door or sink, within a patient zone, or within a family zone.

Additionally, the various networks and systems described herein provide automatic high resolution location data collection that may be used in a plurality of different ways. By receiving continuously updated location information about various assets, such as people, equipment, and supplies, system 10 maintains an accurate database (such as database 40) of the current locations of such assets. Additionally, by retaining a history of such location data, the status and/or use of assets may readily be determined by applying certain logical rules, such as compliance with hygiene requirements for caregivers. Further, non-location and/or location independent status and use information is stored in database 40, such as medications taken. As such, logical rules may be derived from high resolution location information, non-location and/or location independent information.

As also stated herein, network 16 is primarily configured to provide generally complete coverage of the facility for communication purposes, as opposed to being configured for high resolution locating and tracking, such that client devices 26 are generally always capable of communicating with the rest of system 10. This also permits tracking of low resolution location information of the asset associated with client device 26 based on the access point 21 of network 16 which receives signals from client device 26.

In one embodiment, system 10 includes client devices 26 which are responsive to voice commands. System 10 further includes appropriate logical software 38 to permit users to interact with the rest of system 10 and other users in a hands-free or near hands-free manner. System 10 still maintains and updates a high resolution location and status/use database, such as database 40.

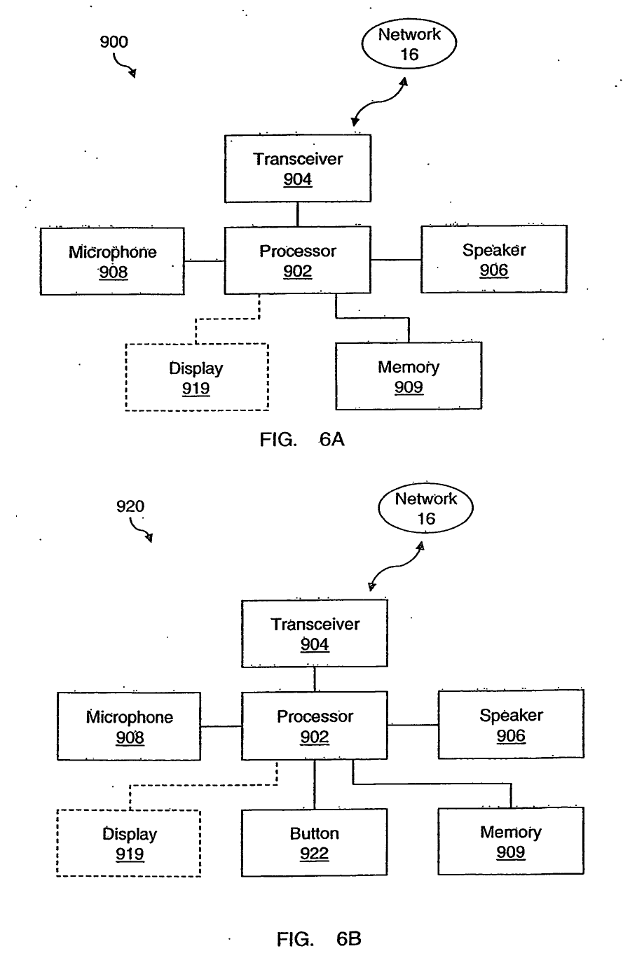

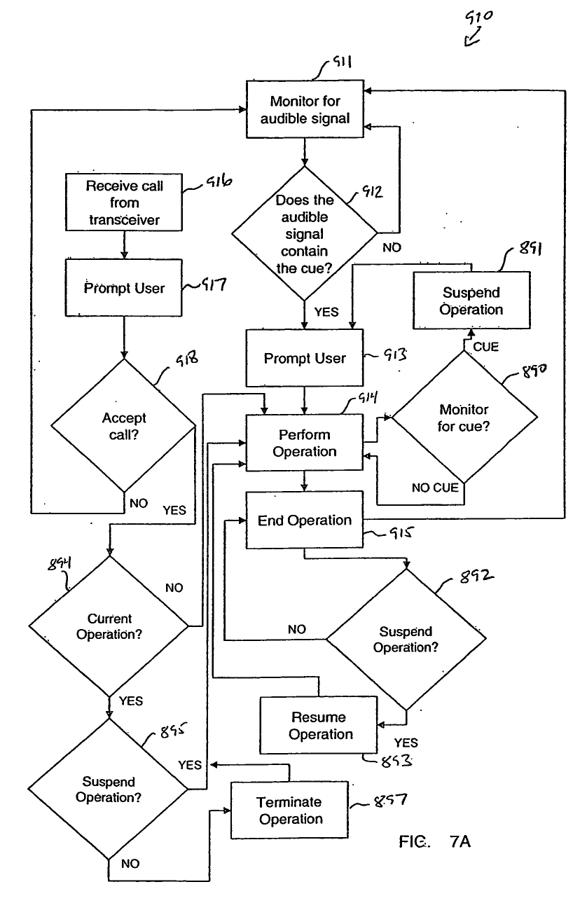

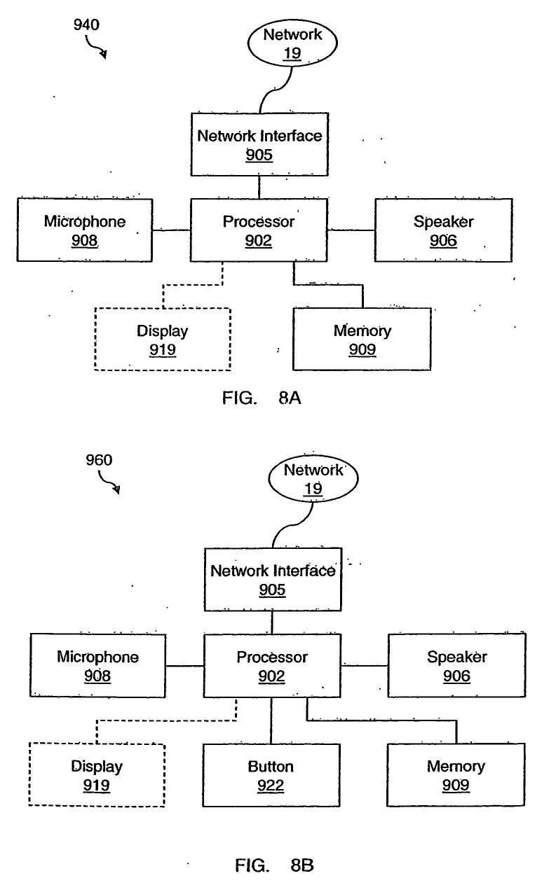

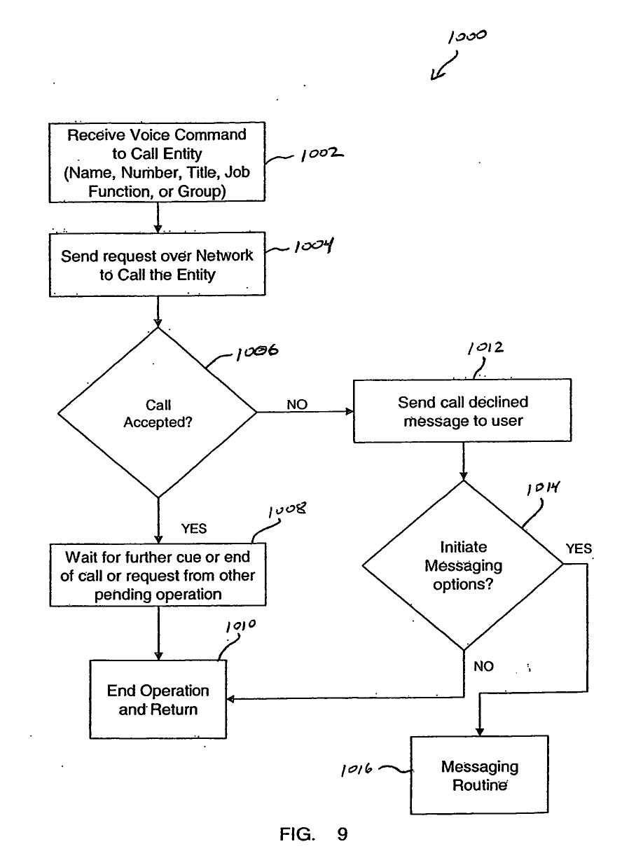

As such, users of client devices 26 have the use of hands-free or near hands-free communication and control along with the ability to leverage the high resolution location information, location-derived status/use information, non-location information, and/or location-independent status/use information. It should be understood that client device 26 may be a communicator, such as communicator 880. Further, communicator 880 may be a hands-free communicator and/or a near hands-free communicator. In one example, communicator 880 may be a portable communicator, such as communicators 900, 920 (FIGS. 6A-B) described below, or a fixed communicator, such as communicators 940, 960 (FIGS. 8A-B) described below.

In a near hands-free embodiment, such as communicators 920, 960, a physical cue is required to indicate that a voice signal, such as a command and/or message, is being presented. In one example, the physical cue is generic for all near hands-free communicators, such as a button. In another example, the physical cue is customizable for each communicator and/or each user, such as a PIN code, fingerprint identification, or other biometric identification. It should be understood that verification information related to the custom physical cue may be stored in a local memory of the respective communicator or in a database accessible by system 10, such as database 40.

In a hands-free embodiment, such as communicators 900, 940, an audible cue may be required to indicate that a voice signal, such as a command or message is being presented. In one example, hands-free communicators 900, 940 recognize a keyword as an audible cue, such as “Communicator.” In certain preferred embodiments, the keyword and/or generally phonetically similar words are not typically used in general conversation in the healthcare industry. In other embodiments, the audible cue is a common term or other easily recognizable audible signal.

In still another example, the audible cue is a sound or series of sounds, such as a clap. In yet another example, the audible cue is generic for all communicators. In a further example, the audible cue is customizable for each communicator and/or user. It should be understood that verification information related to the custom audible cue may be stored in a local memory of the respective communicator or in a database accessible by system 10, such as database 40.

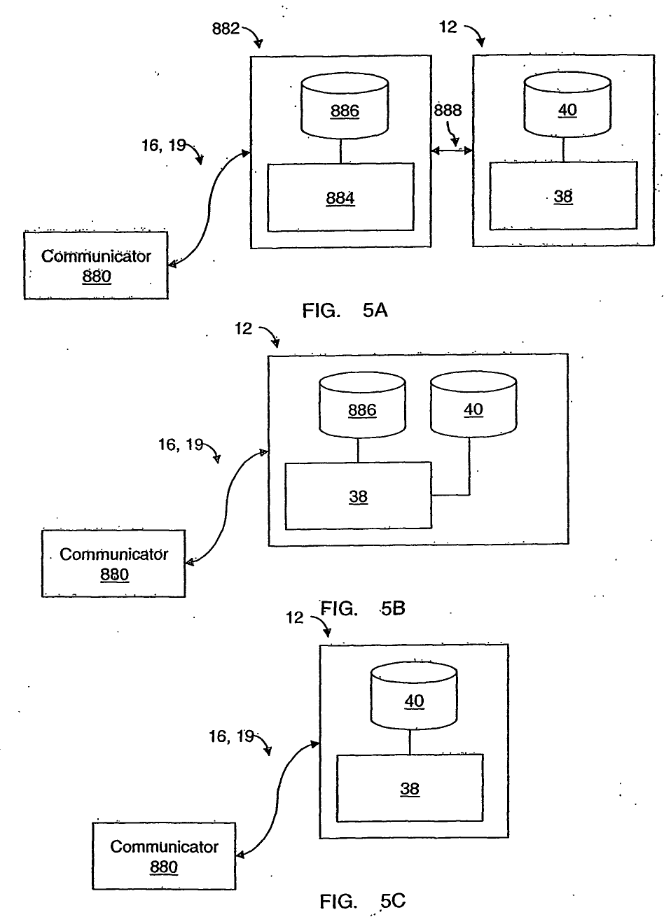

Turning to FIG. 5A, in one embodiment, hands-free communicators and near hands-free communicators, denoted generally as communicators 880, communicate or interact with server 882 through at least one of network 16, 19. Server 882 includes logical software 884 and associated databases 886 to interact with the voice commands generated by communicators 880. Database 886 may include user information, such as login information, voice characteristics, voice commands, missed call queues (described herein), message queues (described herein), event queues (described herein) and additional information.

Portable communicators described generally herein as communicators 900, 920 interact with server 882 over network 16. Fixed communicators described generally herein as communicators 940, 960 interact with server 882 over network 19 (or alternatively network 18). Server 882 is connected to server 12 and hence logical software 38 and database 40 through connection 888. As such, server 882 can query database 40 for various location, status, and/or use information, such as the high resolution data described above. Additionally, server 882, like server 12, is able to access networks 34, 36. Therefore, users of communicators 880 may perform all the functionality herein described for client devices 26 through voice commands.

Referring to FIG. 5B, in another embodiment, database 886 is associated with server 12 and maintained separate from database 40. Communicators 880 interact with server 12 over networks 16, 19. Logical software 38 is configured to interact with the voice commands received from communicators 880. Referring to FIG. 5C, in yet another embodiment, database 886 is integrated with database 40 and logical software 38 is configured to interact with voice commands received from communicators 880. Any other configuration of distributed databases and/or logical software is within the teachings provided herein.

An exemplary hands-free portable wireless communicator 900 is shown in FIG. 6A. Hands-free communicator 900 includes a processor 902, a transceiver 904, a speaker 906, a microphone 908, and a memory 909. Hands-free communicator 900 communicates with other communicators or other components accessible by system 10 over a network, such as network 16 (shown in FIGS. 1, 5A-C) and described above. Transceiver 904 transmits signals to and receives signals from network 16. Speaker 906 annunciates the received voice messages. Microphone 908 receives voice messages from the area proximate to communicator 900. Processor 902 includes firmware or is operably coupled to software configured to control the operation of transceiver 904, speaker 906, and microphone 908 and to recognize a cue and various voice commands.

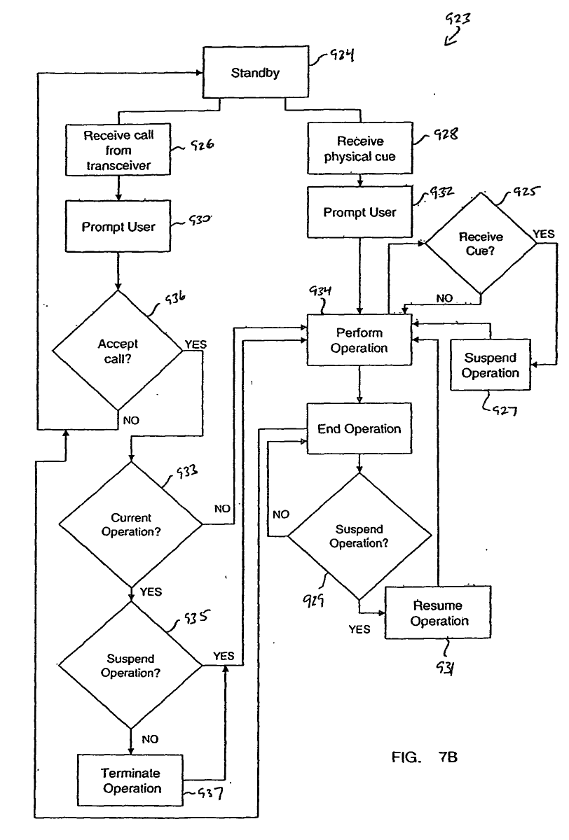

When a person associated with hands-free communicator 900 desires to initiate a voice command, the person provides a cue, such as an audible cue, to microphone 908 which signals processor 902 to monitor for an incoming voice command. FIG. 7A provides an exemplary monitor routine 910 executed by processor 902 for a hands-free communicator, such as communicator 900. As represented by block 911, communicator 900 continually monitors microphone 908 for an audible signal in the absence of a request received by transceiver 904, as discussed below. When an audible signal is detected, processor 902 determines whether the detected audible signal includes the audible cue, as represented by block 912.

In one example, characteristics of the audible cue are stored locally in memory 909 and compared to characteristics of the detected audible signal. In another example, characteristics of the audible cue are stored in a database of system 10, such as database 40 or 886, and are requested by processor 902 through transceiver 904 for comparison to characteristics of the detected audible signal. In yet another example, characteristics of the audible cue are both stored locally in memory 909 and in a database of system 10.

If the characteristics of the detected audible signal matches the characteristics of the audible cue, then processor 902 generates a prompt to the user requesting instructions, such as a voice command, as represented by block 913. In one example, the prompt is an audible prompt sent via speaker 906. In another example, the prompt is one of a visual prompt (an optional display 919), a tactile prompt, or a combination of two or more of an audible prompt, a visual prompt, and a tactile prompt. The user then requests an operation as represented by block 914. In general, exemplary operations include various communication functions, equipment or personnel requests, status updates, or event reporting, such Ws Patient X is leaving surgery. Specific exemplary operations are provided herein.

It should be understood that any operation requested by the user, such as initiating a call to Dr. Smith by stating the voice command “Call” followed by the identifier “Dr. Smith,” may include multiple steps or other operations, and may progress without the need of presenting the audible cue prior to each audible signal. Additionally, in one embodiment communicator 900 may time out after a period of time if no voice command is presented. Further, operations may be suspended in order to process other operations, such as a call waiting feature wherein a first call operation is suspended to receive a second call operation, as represented by blocks 890, 891, and then reinitiated, as represented by blocks 892, 893.

In one example, anytime the user wishes to initiate a voice command the user must tell communicator 900 that a voice command is being presented by preceding the voice command with the audible cue. For example, assuming the user has initiated a call with Dr. Smith, the user may then during the conversation give the audible cue a second time followed by the voice command “Conference Call” followed by the identifier “Dr. Jones.” As such, system 10 recognizes that the user wishes to create a conference call with Dr. Smith and Dr. Jones. By requiring an audible cue prior to a voice command, common phrases, such as “Conference Call,” may be used as voice commands without being mistaken as a voice command when used in normal conversation. In one example, all audible cues are a common keyword, such as “Communicator.” As such, a typical voice request has the structure shown in the following equation:
Voice Re quest=[AudibleCue(Keyword)][VoiceCommand][Identifier]
For example, assuming “Communicator” is the keyword, the following voice request will notify the system to initiate a call: “Communicator Call Dr. Smith.” The system will use the words immediately following the voice command, the identifier, to determine whom to call, “Dr. Smith.” As such, “Communicator Call Dr. Smith” will initiate a call to Dr. Smith. It should be understood that not all voice commands are followed by an identifier. For example, the voice request “Communicator Current Time” will prompt the system to return the current time. Further, some voice commands may be followed by multiple identifiers and/or qualifiers (discussed herein).

The conference call to Dr. Smith and Dr. Jones, described above, may be ended by one of the three parties providing the respective audible cue followed by the voice command “End Call” if the respective user is using a hands-free communicator, one of the three parties providing a respective physical cue if the respective user is using a near hands-free communicator, and/or one of the three parties hanging up the phone if the respective user is using a traditional wired or wireless phone, for example, connected by system 10 through network 36. Block 915 indicates the end of the current operation.

Staying with the above example, assuming Dr. Jones is using a hands-free communicator 900, when the command is given to add Dr. Jones to the conference call, system 10 locates Dr. Jones (either through the access point 21 that detects the communicator 880 associated with Dr. Jones or through the high resolution locating system) and sends the following prompt to Dr. Jones, “Conference call from Dr. Smith and X. Accept Call?” or “Incoming Call. Accept Call?”. The prompt is represented by block 917 and may be an audible prompt, a textual prompt displayed on optional display 919, a tactile prompt, or a combination of two or more of an audible prompt, such as a tone, a visual prompt, such as text, and a tactile prompt. Dr. Jones may then accept the call by giving the voice command “Accept Call” or decline the call by stating “Decline Call,” as represented by block 918. In one example, the call may be accepted or declined without first presenting the audible cue. In another example, in order to accept or decline the call the audible cue must be presented prior to the respective voice command.

Also as shown in FIG. 7A, a user of communicator 900 may receive a request over network 16 through transceiver 904, as represented by block 916. In one embodiment, if Dr. Jones is already engaged in another conversation or operation, communicator 900 provides an audible prompt similar to call waiting features on traditional phones. Communicator 900 and system 10 are configured to permit Dr. Jones to suspend a current call or operation and to toggle to the incoming call and back and forth, generally represented by blocks 894, 895.

Additionally, operations may be terminated, as represented by block 897. Further, options similar to Caller ID, Call Forwarding, Voice Mail, and other suitable calling features may be incorporated into the functionality of communicator 900. Additionally, if Dr. Jones has left the facility and is no longer detected by system 10, system 10 will either transfer the call to Dr. Jones'voice mail, state in a prompt that Dr. Jones is unavailable, or transfer the call to another number assigned to Dr. Jones for an outside network, such as a mobile number associated with a cellular network.

Referring to FIG. 6B, an exemplary near hands-free portable wireless communicator 920 is shown. Communicator 920 is generally similar to communicator 900, expect that a button 922 is included to provide a physical cue to processor 902 that a voice command is being presented to microphone 908.

When the caregiver associated with communicator 920 desires to initiate a voice command or perform other voice related functions, the caregiver provides the respective physical cue, depresses button 922, which signals processor 902 to monitor for an incoming voice command. Additionally, in one embodiment communicator 920 may time out after a period of time if no voice command is presented. FIG. 7B provides an exemplary routine 923 executed by processor 902 for a near hands-free communicator, such as communicator 920.

As represented by block 924, communicator 920 is in a standby mode until a request is received over network 16 through transceiver 904, as represented by block 926, or until the respective physical cue is received, as represented by block 928. If either a request is received, as represented by block 926, or a physical cue is received, as represented by block 928, communicator 920 prompts the user for instructions, as represented by blocks 930 and 932, respectively. In one example, the prompt is an audible prompt sent via speaker 906. In another example, the prompt is one of a visual prompt, a tactile prompt, or a combination of two or more of an audible prompt, a visual prompt, and a tactile prompt.

Assuming the user provided a physical cue, the user responds to the prompt with a requested operation which is then performed, as represented by block 934. It should be understood that any operation requested by the user, such as initiating a call to Dr. Smith by stating “Call to Dr. Smith” may include multiple steps or operations and may process without the need of presenting the physical cue prior to each audible signal. However, in one example, any time the user wishes to initiate a voice command, the user must provide the physical cue before stating the voice command. Similar to monitor routine 910, routine 923 permits the user to suspend a current operation to initiate a second operation, as represented by blocks 925, 927. Also, suspended operations may be resumed, as represented by blocks 929, 931.

Further, similar to routine 910, a user of communicator 920 may receive a request through transceiver 904, as represented by block 926. The user is prompted whether to accept the call or not, as represented by blocks 930, 936. In one example, the call may be accepted or declined without first presenting the physical cue. In another example, in order to accept or decline the call, the physical cue must be presented prior to the respective voice command. If a current operation is active, then the current operation may be suspended, as represented by blocks 933, 935. Operations are terminated at block 937.

Similar to communicator 900, communicator 920 is capable of various calling features including Call Waiting, Caller ID, Call Forwarding, Voice Mail, and other suitable calling features, and is capable of connecting to external networks, such as a cellular network.

Client devices 26 as described herein include many of the features of hands-free portable communicators 900 and near hands-free portable communicators 920. However, client devices 26 require the user to select options from a menu-driven system to initiate voice communication or perform other related functions. By incorporating the functionality of a hands-free communicator or near hands-free communicator into the client devices 26, client devices 26 are configured to provide the same functionality as described herein with voice commands as opposed to menu-driven commands. In one example, as the user provides voice commands, display 27 of client device 26 shows the corresponding menu selections if applicable.

Other exemplary portable communicators compatible with network 16, along with exemplary voice commands and database configurations, are described in U.S. patent application Ser. No. 09/947,235, published as U.S. Published Patent Application No. US2003/0045279A1, to Shostak, entitled “VOICE-CONTROLLED WIRELESS COMMUNICATIONS SYSTEM AND METHOD” and U.S. patent application Ser. No. 10/231,720, published as U.S. Published Patent Application No. US2003/0073434A1, to Shostak, entitled “VOICE-CONTROLLED WIRELESS COMMUNICATIONS SYSTEM AND METHOD,” both disclosures of which are expressly herein incorporated by reference. Further, exemplary portable communicators including exemplary voice commands and database configuration are sold by Vocera Communications, located at 20600 Lazaneo Drive, 3rd Floor, Cupertino, Calif. 95014 and on the Internet at http://www.vocera.com. In one embodiment, portable communicators are designed to be worn by a user like a wrist watch. Exemplary wrist watch devices are described in U.S. Published Patent Application No. US2002/0057203A1, Ser. No. 10/039,342, filed Jan. 8, 2002, the disclosure of which is expressly incorporated by reference herein.

As previously stated, communicator 880 may be a fixed hands-free communicator, such as communicator 940 shown in FIG. 8A, or a fixed near hands-free communicator, such as communicator 960 shown in FIG. 8B. Fixed communicators 940, 960 function similar to portable communicators 900, 920 except that the location of communicators 940, 960 is fixed. In one embodiment, fixed communicators 940, 960 are incorporated into transceivers, such as transceivers 18, 20, RAS, such as RAS 140, workstations, such as workstations 28, bed communication devices, and/or stand alone communicator devices. Exemplary bed communication devices and other controllable bed devices are disclosed in the above-referenced locating and tracking patents and patent applications incorporated by reference and in U.S. Pat. No. 5,715,548, filed Feb. 10, 1998, entitled “Chair Bed,” and U.S. Pat. No. 6,560,798, filed Sep. 26, 2002, entitled “Hospital Bed Communication and Control Device”, the disclosures of which are incorporated by reference herein.

Hands-free fixed communicator 940 executes a similar routine as hands-free portable communicator 900 and as shown in FIG. 7A. Communicator 940 includes a network interface 905 which couples or otherwise connects communicator 940 to network 19. Since hands-free fixed communicator 940 is not assigned to a particular person, in one embodiment, hands-free fixed communicator 940 includes security measures to ensure that a received voice command is being given by a person with the appropriate authorization to give the voice command.

In one embodiment, hands-free fixed communicator 940 includes a transceiver similar to transceivers 18 or 20 and detects the identification signal presented by all (tags 22, 24) proximate to hands-free fixed communicator 940. Hands-free fixed communicator 940 requests that system 10 send the access level associated with the detected personnel and/or the voice characteristics associated with the detected personnel or simply any indication of whether any of the detected personnel have the required access level. In one example, hands-free fixed communicator 940 compares the required access level for the received voice command with the access level of the detected personnel to determine if any of the personnel have the appropriate access level. In another example, hands-free fixed communicator 940 further compares the voice characteristics of the received voice command with the retrieved voice characteristics to determine if any of the personnel have the appropriate access level and if the person associated with the tag is the same person providing the voice command. If the voice command is from a person having the appropriate authorization, hands-free fixed communicator 940 communicates to the user that the request is accepted. Otherwise, hands-free fixed communicator 940 communicates to the user that the request is denied.

In another embodiment, hands-free fixed communicator 940 sends the received voice command and/or information related to the detected tags 22, 24 to server 12. In one example, logical software 38 compares the required access level for the received voice command with the access level of the detected personnel to determine if any of the personnel have the appropriate access level. In another example, logical software 38 compares the voice characteristics of the received voice command with the retrieved voice characteristics to determine if any of the personnel have the appropriate access level. If the voice command is from a person having the appropriate authorization, hands-free fixed communicator 940 communicates to the user that the request is accepted. Otherwise, hands-free fixed communicator 940 communicates to the user that the request is denied.

Near hands-free fixed communicator 960 executes a similar routine as near hands-free portable communicator 920 and as shown in FIG. 7B. Communicator 960 includes a network interface 905 which couples or otherwise connects communicator 940 to network 19. In one example, near hands-free fixed communicator 960 includes a transceiver similar to transceivers 18 or 20 and detects the identification signal presented by all users proximate to near hands-free fixed communicator 960. Near hands-free fixed communicator 960 requests that system 10 send the access level associated with the detected personnel or an indication of whether any of the detected personnel have the required access level. In one example, near hands-free fixed communicator 960 compares the required access level for the received voice command with the access level of the detected personnel to determine if any of the personnel has the appropriate access level. In another example, near hands-free fixed communicator 960 further compares the voice characteristics of the received voice command with retrieved voice characteristics to determine if any of the personnel has the appropriate access level and if the person associated with the tag 22, 24 is the same person providing the voice command. If the voice command is from a person having the appropriate authorization, near hands-free fixed communicator 960 communicates to the user that the request is accepted. Otherwise, near hands-free fixed communicator 960 communicates to the user that the request is denied.

It should be understood that fixed communicators 940, 960 may be used to provide information to a user. For instance, if an incoming call is for Dr. Smith, server 12 checks database 40 to determine the location of Dr. Smith and then forwards the call to the communicator 940, 960 proximate to Dr. Smith or to one of communicator 900, 920, if Dr. Smith is carrying one of communicator 900, 920. Dr. Smith can accept or decline the call by providing the appropriate cue and voice command.

Regardless of the type of communicator 880 used, hands-free communicators 900, 940, near hands-free communicators 920, 960, other client devices 26 including the voice capabilities of hands-free communicators 900, 940 and near hands-free communicator 920, 960, andlor other devices including the voice capabilities of hands-free communicators 900, 940 and near hands-free communicator 920, 960, the present invention contemplates several exemplary applications utilizing voice commands and communication.

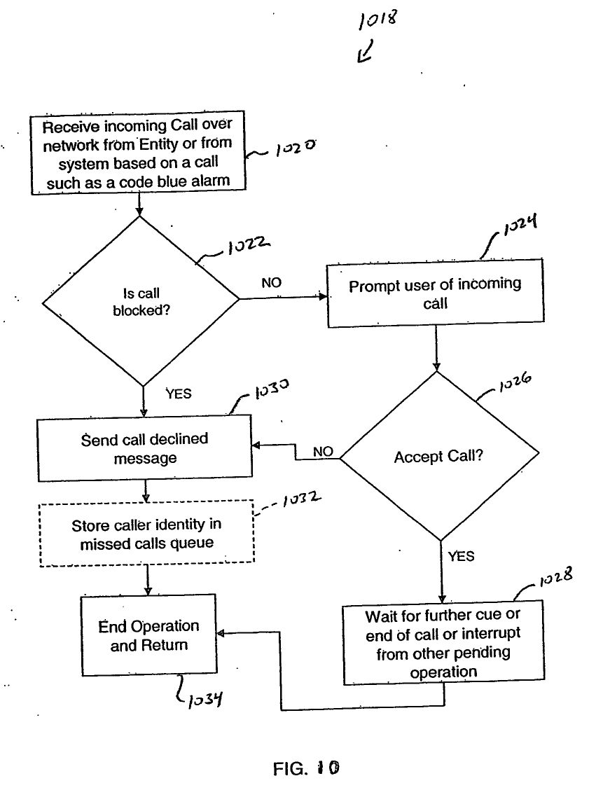

For example, in one embodiment, the call routine discussed above in connection with FIGS. 10-14 is carried out with hands-free communicators 900, 940 or near hands-free communicators 920, 960. Referring to FIG. 9, an exemplary call initiation routine 1000 is shown. It should be understood that call initiation routine 1000 is executed by hands-free communicators 900, 940 and near hands-free communicators 920, 960 at the respective perform operation blocks 914, 934 in respective figures, FIG. 7A, FIG. 7B.

Returning to FIG. 9, as represented by block 1002, the respective communicator receives a voice command to call an entity. Exemplary entities include a person, an organization, a group, or system 10. Further, for a given entity the voice command can identify the entity by a name, a number, a title, a job function, or a group. For instance, a call may be placed to “Dr. Smith”, extension “5273”, “Director of Human Resources”, “IT Helpline”, or “Nurses”. Also, a call may be made to server 12 to query database 40.

Once the voice command to call the entity is received, communicator 880 sends a request over network 16, 19 to call the given entity, as represented by block 1004. An exemplary Call voice command is “Call.” As such, a voice request might be “Communicator Call Dr. Smith”. In one example, communicator 880 includes a listing of known voice commands and compares the received voice command to the list of known voice commands to verify that received voice command is a known voice command. In another example, communicator 880 simply forwards the received voice command and associated identifiers and qualifiers, if any, to server 12. Logical software 38 is configured to analyze the voice command and compares the voice command to a list of known voice commands to determine the desired function.

As represented by block 1006, communicator 880 receives a signal back over network 16, 19 as to whether the call was accepted or declined. If the call was accepted, then communicator 880 permits the user to carry on a conversation with the entity and waits for a further cue, either audible or physical, an end of the current call, or a request received through the respective transceiver indicating another pending operation. It should be understood that if a further cue or other pending operation is detected, the current call operation may be suspended and later resumed or may be terminated. As represented by block 1010, once the current operation is ended, communicator 880 is returned to its monitoring loop or standby mode or to other pending operations.

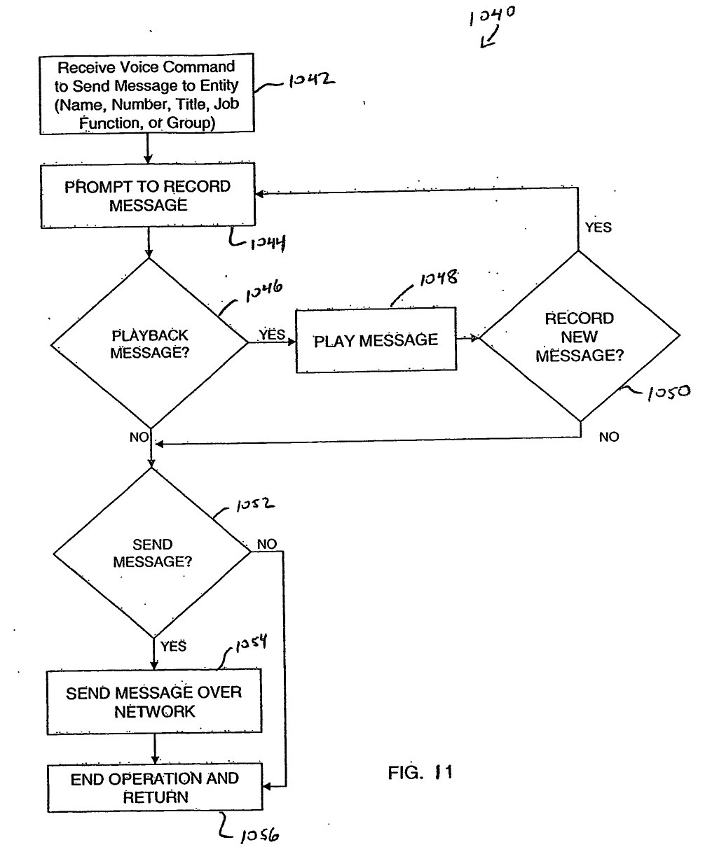

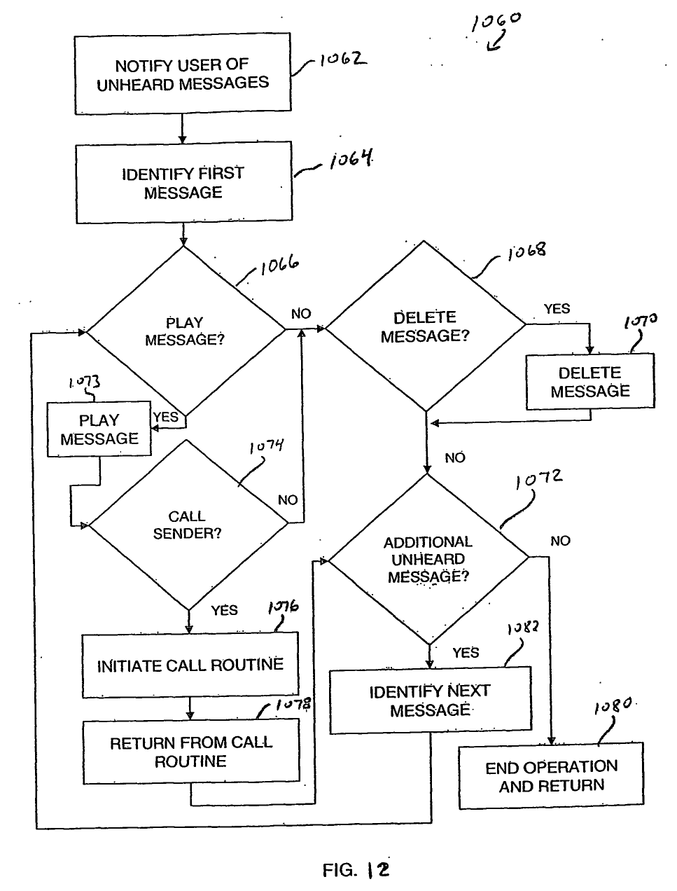

If the call to the entity was declined, as explained in more detail below in connection with FIG. 10, communicator 880 sends a call denied message to the user, as represented by block 1012. Communicator 880 next gives the user the option of initiating a messaging routine, such as messaging routine 1040, which allows the user to send a message to the entity, as represented by block 1014. If the user chooses not to initiate the messaging routine, then the call routine 1000 is ended, as represented by block 1010. However, if the user decides to initiate the messaging routine, communicator 880 next invokes messaging routine 1040 (shown in FIG. 11), as represented by block 1016.

In a first example, a user, Dr. Smith, initiates call routine 1000 to call Dr. Jones. By way of an example, Dr. Smith after providing the respective audible or physical cue states the voice command “Call” followed by the identifier “Dr. Jones.” Communicator 880 sends the request to call Dr. Jones over network 16, 19. Server 12 receives the request to call Dr. Jones and determines the location of Dr. Jones either through network 14, network 16, or network 19. Server 12 then sends a message to communicator 880 associated Dr. Jones, either fixed or portable, stating that a call from Dr. Smith is incoming, as explained herein with reference to FIG. 10. Assuming Dr. Jones accepts the call, Dr. Smith's communicator 880 provides the verbal message to Dr. Smith “Call accepted, please begin conversation.”

In another example, Technician Jones is working with a piece of equipment and desires to speak with a technical expert from the manufacturer of the piece of equipment. In such a situation, Technician Jones may provide the voice command “Call” followed by the identifier “Customer support for asset A”. A request is sent to server 12. Server 12 through database 40 determines the customer support number associated with asset A and initiates a call through external communication system 36. Once the customer support line answers the call, Technician Jones communicator 880 states “Call accepted, begin conversation now.” In another example, server 12 looks at the current location of Technician Jones and the various assets that are detected at the same location, and initiates a call based upon the asset that is proximate to Technician Jones.

In another example, Dr. Smith may wish to provide feedback on Resident Jones because Resident Jones has assisted Dr. Smith in providing care to Dr. Smith's patients. As such, Dr. Smith sends the following voice command “Call” followed by the identifier “Supervisor for Resident Jones.” Server 12 references database 40 to determine the supervisor currently assigned for Resident Jones and attempts to complete a call to the supervisor.

In yet another example, Dr. Smith may wish to determine the allergies of Patient Jones before prescribing medication. As such, Dr. Smith sends the following voice command “Call” followed by the identifier “Patient Allergy Database” Once the call is completed Dr. Smith is prompted for the patient name or patient id requested.

In a further example, Dr. Smith may wish to speak to someone in IT support. As such, he can send the voice command “Call” followed by the identifier “IT support.” Server 12 references database 40 and initiate a call to the IT support line and connects Dr. Smith.

It should be understood that Dr. Smith may also provide qualifiers after the identifier. For example, Dr. Smith may state the voice command “Call” followed by the identifier “IT support” followed by the qualifier “Closest Location.” Server 12 references database 40 to determine the IT staff member whose location is the closest to Dr. Smith and connects Dr. Smith to that person.

In yet a further example, Dr. Smith may wish to send a call to a group of people such as Surgical Team A. This may be done by issuing the voice command “Call” followed by the identifier “Surgical Team A.” As such, it is possible to call a group of people with a single command.

It should be understood that calls initiated through communicator 880 may be routed to another communicator 880, a paging system, a traditional phone system, a cellular phone system, an RSA, such as RAS 140 discussed above, or other suitable communication devices and networks accessible by system 10.

Referring to FIG. 10, an incoming call routine 1018 is shown. Incoming calls may be initiated from other communicators 880 using call routine 1000, paging systems, traditional phone networks, cellular networks, or other communication networks connected to system 10. Further, incoming calls may be generated by server 12 based upon the updated location information of persons and assets and use/status information of assets. For example, server 12 detecting a code blue situation can automatically dispatch calls to communicators 880 which are associated to caregivers who are in the proximity of the code blue situation and/or caregivers which are assigned to the patient associated with the code blue situation. Further, incoming calls may be initiated by server 12 based upon the location information of various tags 22, 24. For example, the detection of a patient leaving an operating room could trigger a call to appropriate caregivers to prepare a recovery room to notify family members, or to notify appropriate caregivers that the patient will soon be located in the recovery area.

As represented by block 1020 in FIG. 10, the incoming call is received from network 16, 19 by communicator 880. Communicator 880 may be configured to block incoming calls based on priorities, calling entities, or calls in general. As such, a user of communicator 880 will not receive unwanted calls while engaged in a meeting or other activity. As represented by block 1022, communicator 880 checks to see if the incoming call is a currently blocked call. If the call is not blocked, communicator 880 prompts the user of the incoming call, as represented by block 1024. An exemplary prompt is “Call from Dr. Smith. Accept call?” The user then responds with a voice command to either accept the call “Accept call” or to decline the call “Decline call.” If the call is accepted, then communicator 880 permits the conversation to transpire, as represented by block 1028.

If the call is not accepted, communicator 880 sends a call declined message through network 16, 19, as represented by block 1030. Server 12 then notifies the calling party that the call has been declined. In one example, either server 12 or communicator 880 keeps a list of declined callers in a missed call queue as represented by block 1032. As such, the user of communicator 880 is provided with a list of all callers who have attempted to call communicator 880, but were declined. If the call is declined or once the call is ended, functionality is returned to the monitoring or standby routines of communicator 880, as represented by block 1034.

Referring to FIG. 11, a message routine 1040 is shown. As represented by block 1042, communicator 880 receives a voice command to send a message to an entity. Similar to the “Call” voice command, the “Send Message” voice command may be sent to a name, a number, a title, a job function, server 12, or a group. Communicator 880 then prompts the user to record the message, as represented by block 1044. An exemplary prompt is “Please record message after the tone” followed by a tone. Once the user has completed the message detected by communicator 880 by either a cue, a cue followed by a voice command, and/or silence for a predetermined period of time, the user is given the option to have the message replayed, as represented by block 1046.

If the user decides to have the message replayed, communicator 880 plays the message, as represented by block 1048. After the user has heard the replay of the message, the user is presented with a prompt asking if they wish to record a new message, as represented by block 1050. If the user responds with a “Yes” voice command, communicator 880 again prompts the user to record the message, as represented by block 1044. If the user responds with a “No” voice command, the user is then prompted whether to send the message or not, as represented by block 1052. If the user chooses to send the message (responds with a “Yes” voice command), the message is sent over network 16, 19 to the respective entity, as represented by block 1054 and the operation is ended as represented by block 1056. If the user decides not to send the message (responds with a “No” voice command), then the operation ends, as represented by block 1056. The message sent by the user as discussed above, is received by the communicator 880 associated with the recipient. The associated communicator 880, either portable or fixed, initiates the receive message routine 1060 as shown in FIG. 12. The user is notified of unheard messages, as represented by block 1062. It should be understood if communicator 880 is not currently blocking the call, communicator 880 identifies the unheard message, as represented by block 1064. An example identifier is “Unheard message from Dr. Smith.” However, if the message call is blocked, communicator 880 in one example adds the message to a message queue, the contents of which are presented to the user once the calls are unblocked.

The user is then prompted whether they wish to play the message, as represented by block 1066. If the user responds with a “No” voice command, then the user is next prompted whether to delete the message, as represented by block 1068. If the user responds with a “Yes” voice command, the message is deleted, as represented by block 1070. If the user responds with a “No” voice command, the message is retained in the message queue and communicator 880 queries to see if additional unheard messages are present in the message queue, as represented by block 1072. In one embodiment, messages may be forwarded to another entity.

Returning to block 1066, if the user instead decides to play the message by responding with a “Yes” voice command, the message is played for the user, as represented by block 1073. After the message has been played, the user is prompted whether they wish to call the sender, as represented by block 1074. If the user responds with a “No” voice command, the user is then presented with the option to delete the message, as represented by block 1068. If the user responds with a “Yes” voice command, then call routine 1000 is initiated, as represented by block 1076.

The receive messages routine 1060 is suspended while call routine 1000 is active. Once call routine 1000 has terminated, the user is returned to message routine 1060, as represented by block 1078. Communicator 880 next checks to see if additional unheard messages are present in the queue, as represented by block 1072. If additional messages are not present in the queue, the receive message routine 1060 ends operation, as represented by block 1080. In one example, the system provides the message to the user “no unheard messages.” If additional unheard messages are present in the queue, communicator 880 identifies the next message in the queue, as represented by block 1082, and the user is again presented with the option to play the message, as represented by block 1066. The message routine 1060 continues until all unheard messages have been considered. However, as explained above, message routine 1060 like other operation routines may be suspended or interrupted by other operations.

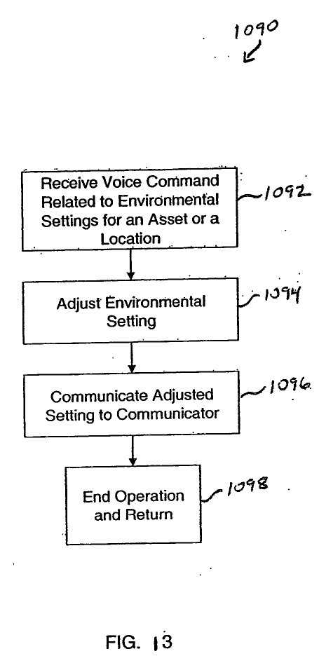

Turning to FIG. 13, an environmental setting routine is shown. As described herein, various environmental settings including lighting, audio and television volumes, bed controls, and other settings may be automatically controlled by the detection of a tag 22, 24 within a particular area, such as a caregiver entering a patient room. With environmental setting routine 1090, the environmental settings for a particular area may be adjusted based upon voice commands received by communicator 880. As represented by block 1092, communicator 880 receives a voice command related to an environmental setting for an asset or a location. An exemplary voice command would be “mute television.” The voice command is forwarded to server 12, which in turn causes the environmental setting to be adjusted. In the example of muting the television, server 12 determines the current location of the person associated with communicator 880 initiating the request through database 40 and the television proximate to that location. The system then sends a signal to the television to mute the television. In one example, once the caregiver leaves the area, the television is returned to its previous settings. As represented by block 1096, the adjusted setting is communicated to the user through communicator 880. An example, message would be “Television muted.” Alternatively, if the environmental setting change requested cannot be processed, server 12 notifies the requestor with a message such as “Not able to mute television at this time.” As represented by block 1098, the operation is then ended.

An ambulatory navigation system for persons within a facility may be implemented with communicators 880. An exemplary ambulatory navigation system is provided in co-pending application Ser. No. 09/798,398, published as U.S. Published Patent Application No. US2002/0123843A1, filed Mar. 2, 2001, the disclosure of which is expressly incorporated herein by reference. In general, the disclosed ambulatory navigation system provides a user with instructions on how to reach a given location in a facility from the current location of the user.

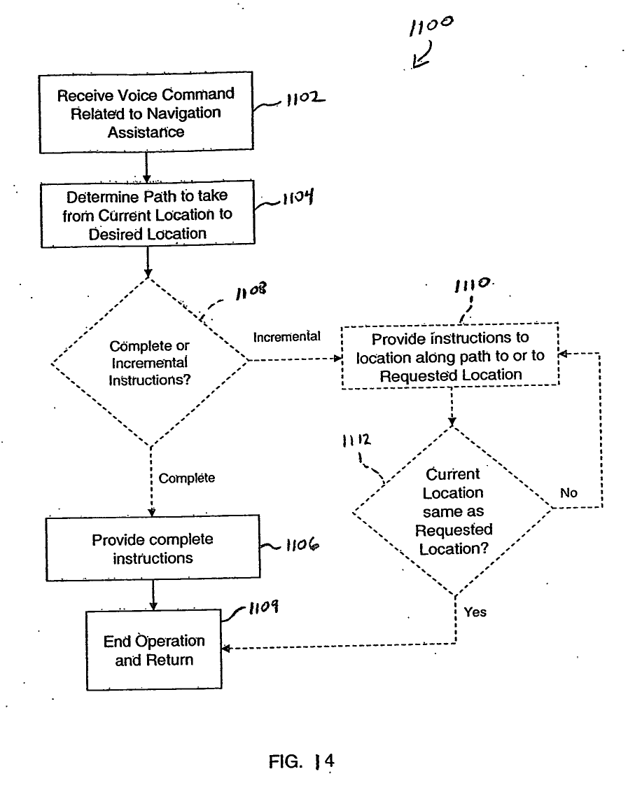

Turning to FIG. 14, an exemplary navigation assistance routine 1100 for use with communicators 880 is shown. Communicator 880 receives a voice command related to navigation assistance as represented by block 1102. An example voice command would be “Navigation Instructions” followed by the identifier “Location X.” In response to the voice command, server 12 determines a path from the current location of the user stored in database 40 to the requested location, as represented by block 1104. It should be understood that the determined path should be selected based upon areas that the user has privilege or access to enter. The access level of the user is stored in database 40. Server 12 then provides instructions from the current location to the requested location to the user, as represented by block 1106.

Alternatively, the user is first prompted regarding whether the user prefers to receive complete instructions or incremental instructions, as represented by block 1108. If the user responds with the voice command, “Complete Instructions,” the user is provided with complete instructions, as represented by block 1106 and the operation ends, as represented by block 1108. If the user responds with the voice command, “Incremental Instructions,” the user is first provided instructions to a location along the path to the requested location proximate to the current location. For example, the instructions to the incremental location may be “head west along corridor to the bank of elevators.” Next, the current location of the user is compared to the requested location to determine if the user is at the requested location, as represented by block 1112. If the current location and the requested location are the same, then the operation ends, as represented by block 1109. However, if the current location is not the same as requested location, the user is provided with incremental instructions to a location along the path from the now current location to the requested location, as represented by block 1110.

In all situations the voice commands presented to the system and instructions received from the system may be configured based upon the language options of the user such as language type. Further, the voice commands may be configurable such that the use of acronyms are possible as well as general voice commands.

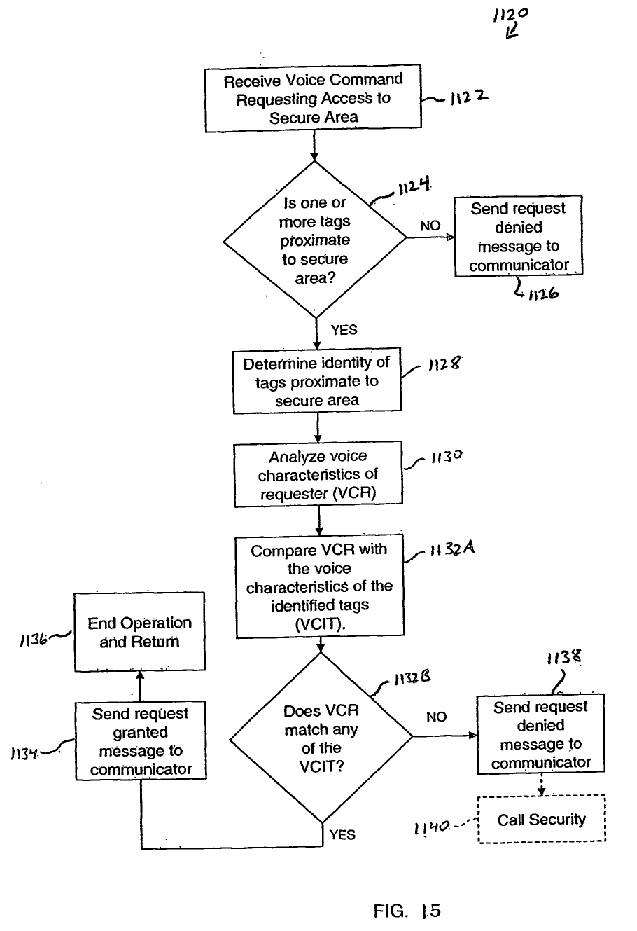

Referring to FIG. 15, a secure access routine 1120 is shown. Often times a given area, such as a portion of a facility or a medicine cabinet, may be locked and a user has to request access to such area. Access to a secure area is based upon the access level of the requester. In some systems, the identification of the tags proximate to an entrance to the secure area are used to assist in determining if the requester has the required access level.

Secure access routine 1120 uses both the identification of tags proximate to the entrance of the secure area and the voice characteristics of the person requesting access to determine whether the requestor is authorized to gain access to the secure area. As represented by block 1122, communicator 880 receives a voice command requesting access to the secure area. A exemplary voice command is “Unlock medicine cabinet.” This voice command is then processed by server 12, which checks to see if one or more tags 22, 24 are proximate to the secure area, as represented by block 1124. If no tags 22, 24 are detected proximate to the secure area, then a message is sent to the requesting communicator 880 stating that access is denied, as represented by block 1126. If one or more tags 22, 24 are positioned approximate to the secure area, server 12 determines the identity of the tags 22, 24 proximate to the secure area, as represented by block 1128.

Further, the system analyzes the voice characteristics of the voice command, as represented by block 1130. The voice characteristics from the voice command are compared to the voice characteristics associated with the identified tags 22, 24 which are stored in database 40 as represented by blocks 1132A-B. Assuming the two voice characteristics match, the user is sent a request granted message, as represented by block 1134, access is permitted (unlocked), and the operation ends as represented by block 1136. If, however, the two voice characteristics do not match, the user is sent a message indicating that the request is denied, as represented by block 1138. Further, in one embodiment, the system also notifies security personnel proximate to the secure area of the attempted unauthorized entry, as represented by block 1140.

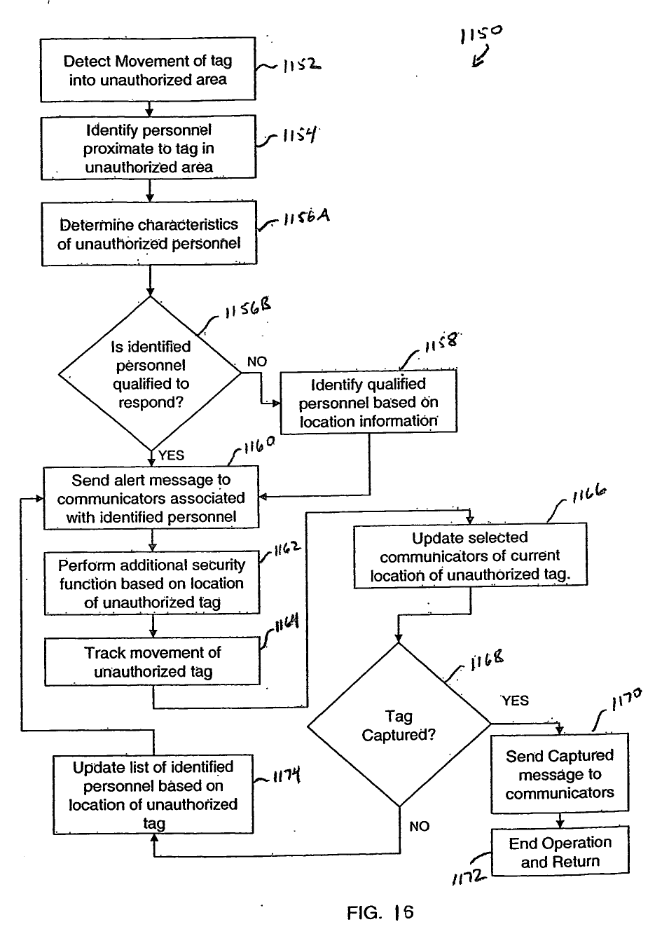

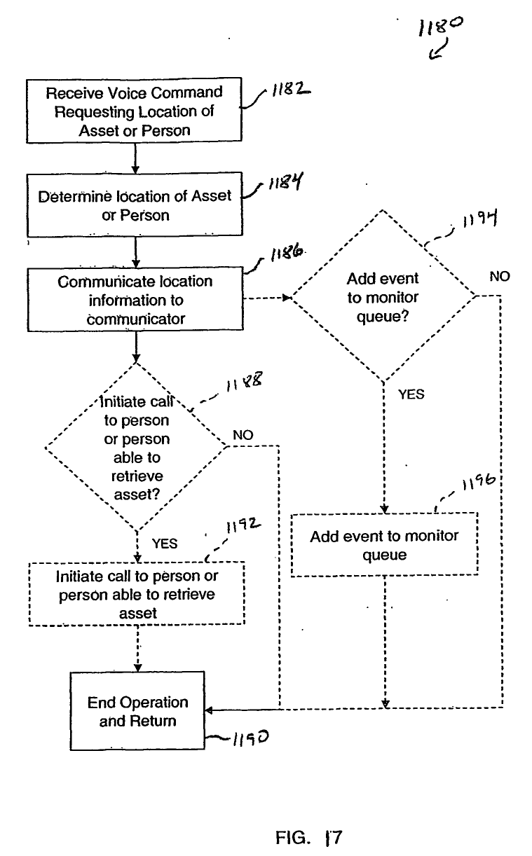

Shown in FIG. 16 is a security routine 1150. Security routine 1150 monitors the movement of tags 22, 24 and detects the movement of tags 22, 24 into an unauthorized area as represented by block 1152. One example of movement of a tag into an unauthorized area is the movement of a piece of equipment beyond the entrance or exit of a facility. Another example of unauthorized movement is the positioning of an infant near an exit of the maternity ward. It is known in infant monitoring systems to automatically engage door locks and alarms based on the proximity of an infant unaccompanied by a caregiver adjacent an exit of a maternity ward.

Once movement of a tag 22, 24 into an unauthorized area is detected, the system identifies personnel proximate to tag 22, 24 which was moved into the unauthorized area, as represented by block 1154. Further, the system determines the characteristics of the personnel proximate to the tag to determine if such personnel are qualified to respond to the unauthorized movement, as represented by blocks 1156A-B. If the personnel are not qualified to respond, then the system identifies the nearest qualified personnel based on the stored location and characteristic data, as represented by block 1158. Once qualified personnel have been identified, an alert message is sent to communicators 880 associated with the identified personnel, as represented by block 1160. In one example, a description of the items associated with tag 22, 24 is given in the alert message along with other characteristics of the item. In addition, the system may provide additional security based on the location of the unauthorized tag 22, 24, such as the locking of doors or an audible alarm, as represented by block 1162.

The system continues to track the movement of the unauthorized tag 22, 24, as long as the tag is detected by the system, as represented by block 1164. As the unauthorized tag 22, 24 moves throughout the facility, the personnel who are proximate to the current location of the unauthorized tag continually changes and the system updates a listing of qualified personnel proximate to the unauthorized tag, as represented by block 1166. The system next determines if the unauthorized tag 22, 24 has been captured, as represented by block 1168. In one example, the system determines the tag 22, 24 has been captured based upon the proximity of the tag to the tag of identified personnel. In another example, the system determines if the tag 22, 24 has been captured when it receives a voice command from a communicator located proximate to the captured tag stating that the tag has been captured.

If the tag 22, 24 has been captured, the system then sends a captured tag message to all communicators 880 which were previously placed on alert, as represented by block 1170, and the operation is ended, as represented by block 1172. If the tag 22, 24 has not been captured, the system updates the list of identified personnel based on the location of the personnel and the location of the unauthorized tag, as represented by block 1174, and sends out an alert message to communicators 880 associated with the identified personnel, as represented by block 1160.

Referring to FIG. 17, a location monitoring routine 1180 is shown. Location monitoring routine 1180 permits a user to request the location of an asset or person to automate the retrieval of the asset or to initiate a call to the person responsible for the asset. Location monitoring routine 1180 further permits a user to monitor the location of an asset or person and be notified of changes in location. For example, a caregiver may be notified when a patient wanders beyond a predetermined boundary or exits his bed.

Communicator 880 receives a voice command requesting location or status information of an asset or person, as represented in block 1182. An example voice command is “Retrieve location” followed by the identifier “Dr. Smith.” Server 12 determines the location and/or status of Dr. Smith and returns that information to communicator 880. Communicator 880 then receives the location and/or status information related to the asset or person, as represented by block 1184, and communicates the location or status information to the user, as represented by block 1186.

The location or status request can include qualifiers following the identifier. For example, a user can give the voice command “Retrieve location” followed by the identifier “Wheelchair” followed by the two qualifiers “Closest” and “Available.” Server 12 will determine the location of all wheelchairs and return the location of the closest available wheelchair. It should be understood that by using the locating and tracking system of network 14 as maintained by database 40, as opposed to a low resolution location system of network 16, the determination of the closest wheelchair may return a location of “at the end of the hall” instead of “directly above the user on the next floor.” However, if communicators 880 are fixed communicators, such as communicators 940, 960, the location of the closest wheelchair may be determined by the location system of network 16 because a knowledge of the location of communicators 940, 960 assists in determining the location of the requester.

The user is then prompted whether they wish to call the identified person, if a person was requested, or to call a person assigned to the asset, as represented by block 1188. If the user responds with the “No” voice command, then the operation is ended, as represented by block 1190. If the user responds with the “Yes” voice command, then call routine 1000 is initiated to either call the identified person or to call a person whose job function and/or proximity is associated with the requested asset, as represented by block 1192.

In one embodiment, the user of communicator 880 requests the location information about a person or asset such as a patient assigned to that user. In one example, the patient is in surgery and the user wishes to verify that the patient is still in surgery. The user is prompted as to whether the user wants to add an event to monitor the location of the patient, as represented by block 1194. For example, the user may wish to monitor when the patient leaves the surgical room such that the caregiver may be prepared to take care of the patient when he arrives in his patient room. If the caregiver responds that he does not want to add an event to an event monitoring queue, then the operation is ended, as represented by block 1190. If the caregiver wants to add an event to the event monitoring queue, then the caregiver provides voice commands related to the event to be monitored, as represented by block 1196.

In addition, communicators 880 may be used to notify caregivers of alerts generated by the exubation prevention method and of alert messages generated by the fall prevention method, both of which are disclosed in co-pending U.S. patent application Ser. No. 10/141,457 referenced above, the disclosure of which is incorporated by reference herein. In one example, the disclosed system sends an alert to communicator 880 of the caregiver assigned to the patient. In another example, the disclosed system sends an alert to communicator 880 of the caregiver determined to be closest to the patient associated with the alert.

In addition, communicators 880 may be used to notify caregivers of alerts or alarms, patient medication information, and/or location data generated by the medication tracking system, including the location of medication, the activation of transmitters, and verification that the medication is in the target location, disclosed in co-pending U.S. patent application Ser. No. 10/211,187, filed Aug. 2, 2002, and published as U.S. Published Application No. US2003/0048187A1, the disclosure of which is incorporated by reference herein. In one example, the disclosed medication tracking system sends an alert, patient medication information, and/or location information to communicator 880 of the caregiver proximate to the medication. In a further example, the disclosed medication tracking system sends an alert, patient medication information, and/or location information to communicator 880 of the caregiver assigned to the patient.

In addition, communicators 880 may be used to notify caregivers of alerts generated by the proximity alarm systems in response to the separation between two tags 22, 24 exceeding a predetermined maximum distance, disclosed in co-pending U.S. patent application Ser. No. 10/430,643, filed May 6, 2003, entitled “MEDICAL EQUIPMENT CONTROLLER,” the disclosure of which is incorporated by reference herein. In one example, the disclosed system sends an alert to communicator 880 of the personnel or caregiver assigned to the one of the two tags 22, 24. In another example, the disclosed system sends an alert to communicator 880 of the personnel or caregiver determined to be closest to the patient associated with the alert. In yet another example, the disclosed system sends an alert to communicator 880 of the personnel or caregiver determined to be closest to the patient associated with the alert and which are qualified to respond to the alert.

While the invention has been illustrated and described in detail in the drawings and foregoing description, such illustration and description is to be considered as exemplary and not restrictive in character, it being understood that only exemplary embodiments have been shown and described and that all changes and modifications that come within the spirit of the invention are desired to be protected.

1. A combined communication and asset locating and tracking system, comprising:
a substantially wireless high resolution locating and tracking system including a plurality of receivers configured to be located in different locations in a facility, the different locations including at least one of floors, rooms, corridors, common areas and portions thereof within the facility;
a substantially wireless communication system including a plurality of access points and voice-activated communicators; and
means for linking the locating and tracking system and the communication system including means for determining a specific location of an asset using a voice command.

2. The system of claim 1, wherein the voice-activated communicators are completely hands-free operable by including means for detecting an audible cue to activate the communicator.

3. The system of claim 2, wherein the audible cue is a clapping sound.

4. The system of claim 2, wherein the audible cue is a verbal command.

5. The system of claim 1, further comprising means for generating an alarm if an asset is near an unauthorized area.

6. The system of claim 1, further comprising means for linking the locating and tracking system and the communication system to non-location information about an asset.

7. The system of claim 1, wherein the location is a sub-area within a room of the facility.

8. A system for locating and tracking persons or assets, comprising:
a plurality of tags, each tag being configured to be assigned to a person or asset;
means for substantially wirelessly transmitting a unique identifier identifying each tag;
a plurality of receivers positioned at known locations in a facility, each receiver being configured to detect the unique identifiers for tags positioned near the receiver;
means operably coupled to the plurality of receivers for monitoring the location of the tags in the facility;
a plurality of voice-activated substantially wireless communicators;
a plurality of transceivers positioned at known spaced-apart locations in the facility, each transceiver being configured to send and receive communication signals to and from the communicators; and
means for locating and tracking the tags in response to a voice command received by a communicator.

9. The system of claim 8, wherein the voice-activated communicators are completely hands-free operable.

10. The system of claim 8, wherein the voice command identifies at least one of a person or asset, further comprising means for linking the voice command to location information for the corresponding person or asset.

11. The system of claim 8, wherein the voice command identifies at least one of a person or asset, further comprising means for linking the voice command to non-location information about the corresponding person or asset.

12. The system of claim 8, wherein the tags and receivers operate using a first substantially wireless transmission means and the communicators and receivers operate using a second substantially wireless transmission means.

13. The system of claim 12, wherein the tags and receivers operate using one of radio frequency and infrared transmissions and the communicators and transceivers operate using a voice over IP communications protocol.

14. A method for monitoring the location of persons or assets, comprising the steps of:
assigning a unique identifier to each of a plurality of tags;
assigning each tag to a person or asset;
positioning a plurality of receivers at different locations in a facility;
receiving at the receivers unique identifier transmissions from the tags;
assigning a plurality of communicators to a plurality of persons;
assigning a plurality of transceivers to different locations in the facility;
receiving at a transceiver a voice command from one of the plurality of persons, the voice command relating to at least one of the persons and assets;
linking the voice command to the corresponding tag identifier information; and
identifying the at least one person or asset in response to the voice command.

15. The method of claim 14, further comprising the steps of:
detecting the presence of a tag proximate to a secure area;
detecting a voice command requesting access to the secure area; identifying the person associated with the detected tag;
comparing a voice characteristic of the detected voice command with a known voice characteristic of the person associated with the detected tag; and
granting access to the entry of the secure area if the voice characteristic of the detected voice command matches the known voice characteristic of the person associated with the detected tag.

16. The method of claim 15, further comprising the steps of:
continuously tracking the location of a tag; and
initiating a voice message relating to the location of the tag.

17. The method of claim 16, further comprising the step of determining whether the tag has entered an unauthorized location.

18. The method of claim 14, wherein the voice command includes a command directed to turning an asset on or off.

19. The method of claim 18, further comprising the step of turning the asset on or off based on the voice command.

20. The method of claim 14, further comprising the step of identifying the location of the person or asset based on the voice command.
